(19) United States
(12) Patent Application Publication
(10) Pub. No.: US 2011/0201532 A1
(43) Pub. Date: Aug. 18, 2011

(54) BENEFIT COMPOSITIONS COMPRISING CROSSLINKED POLYGLYCEROL ESTERS

(76) Inventors: Jennifer Beth Ponder, Cincinnati, OH (US); Hans Henning Wenk, Muelheim (DE); Ulrike Kottke, Linsengericht (DE)

(21) Appl. No.: 13/024,510

(22) Filed: Feb. 10, 2011

Related U.S. Application Data
(60) Provisional application No. 61/303,910, filed on Feb. 12, 2010.

(51) Int. Cl. C11D 3/60; D06L 1/16; B08B 3/00

(52) U.S. Cl. 510/220; 510/405; 510/328; 510/327; 510/513; 510/235; 510/527; 510/516; 8/137; 134/26

(57) ABSTRACT

The instant disclosure relates to fabric or household hard surface treatment compositions comprising a mixture of cross-linked polyglycerol partial esters having the structure of Formula (I)

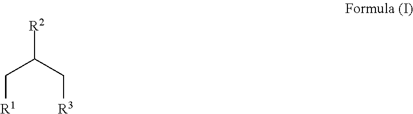

with R¹, R² and R³ each independent from each other, equal or different, and selected from the group consisting of —OH; —OR^{4;} w. and —OR⁵ where R⁵ is a radical having the structure of Formula (I) and R⁴ is a linear, unsubstituted acyl radical with a chain length of from about 16 to about 22 carbon atoms, having the structure of general Formula (II)

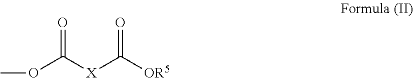

with X a bivalent organic residue with from 2 to 34 carbon atoms with the proviso that the fatty acids obtained from the acyl radical by saponification of —OR⁴ bears an iodine value of smaller than 50 and each molecule of the polyglycerol partial ester mixture comprises at least one of each of an —OR⁵ and —OR⁴ wherein one of R¹, R² or R³ being a direct bond to the oxygen of —OR⁵. The mixture of polyglycerol partial esters comprises an HLB-value from 2 to 10 and the polyglycerol obtained by hydrolysis of the polyglycerol partial ester mixture comprises an average degree of condensation of from 2 to 8 and at least 1% polyglycerol cyclic structures. The fabric compositions also comprise a carrier material suitable for contact with said fabric.

### CROSS-REFERENCES TO RELATED APPLICATIONS

This application claims priority under 35 U.S.C. §119(e) to U.S. Provisional Application Ser. No. 61/303,910 filed Feb. 12, 2010.

### FIELD OF THE INVENTION

The instant disclosure relates to fabric and household hard surface treatment compositions comprising cross-linked polyglycerol esters (PGEs) and a treatment and/or care agent. Methods of making and using said compositions are also disclosed.

### BACKGROUND OF THE INVENTION

Currently available fabric enhancers generally use quaternary ammonium compounds as the principle active to impart a softness benefit to fabrics during the laundering process. Quaternary ammonium compounds, in some instances, can leave a non-consumer preferred feel, such as a greasy feel. A further problem with commonly used quaternary ammonium compound is that such compounds are not stable at high temperatures for prolonged periods of time (greater than 40 C.°). In addition, quaternary ammonium compounds, can be difficult to formulate with, particularly when combined with anionic surfactants as flocculation/precipitation may occur. Further, there is a need for fabric softening agents that may be used in low water or compacted formulations, in contrast to currently used fabric softening agents which may be difficult to formulate as low-water compositions. A further problem with commonly used quaternary ammonium compound based systems is that such systems generally require structurants to achieve a suitable viscosity and/or formulation stability in the presence of other adjuncts such as dye, perfume, and the like. However, such structurants have the negative properties of diminishing the resulting feel benefits and/or cause yellowing and/or negatively affect rheology (e.g., causing stringiness). Accordingly, there is a need for compounds that can providing an improved softening benefit and/or which can be formulated without the need for structurants.

Finally, given the concern for environmentally compatible consumer products, there remains the need for fabric care agents having an improved biodegradeability profile, as many fabric treatment agents are released with the wash/treatment water.

Thus, there is a need in the art to provide fabric care actives having improved attributes with respect to one or more of the aforementioned problems. The instant disclosure addresses one or more of the needs described above.

### SUMMARY OF THE INVENTION

The instant disclosure relates to fabric and household hard surface treatment compositions comprising a mixture of cross-linked polyglycerol partial esters having the structure of Formula (I)

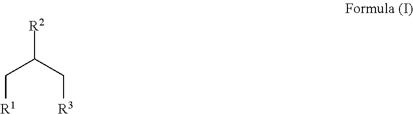

with R¹, R² and R³ each independent from each other, equal or different, and selected from the group consisting of —OH; —OR^{4;} w. and —OR⁵. R⁵ is a radical having the structure of Formula (I). R⁴ is a linear, unsubstituted acyl radical with a chain length of from about 16 to about 22 carbon atoms, having the structure of general Formula (II)

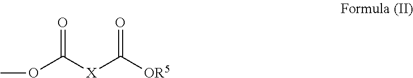

with X a bivalent organic residue with from 2 to 34 carbon atoms with the proviso that the fatty acids obtained from the acyl radical by saponification of —OR⁴ bears an iodine value of smaller than 50. Each molecule of the polyglycerol partial ester mixture comprises at least one of each of an —OR⁵ and —OR⁴ wherein one of R¹, R² or R³ being a direct bond to the oxygen of —OR⁵. The mixture of polyglycerol partial esters comprises an HLB-value from 2 to 10 and the polyglycerol obtained by hydrolysis of the polyglycerol partial ester mixture comprises an average degree of condensation of from 2 to 8 and at least 1% polyglycerol cyclic structures. The fabric compositions also comprise a carrier material suitable for contact with said fabric.

### DETAILED DESCRIPTION OF THE INVENTION

As used herein, the articles including “a” and “an” when used in a claim, are understood to mean one or more of what is claimed or described.

As used herein, the term “comprising” means various components conjointly employed in the preparation of the compositions of the present disclosure. Accordingly, the terms “consisting essentially of” and “consisting of” are embodied in the term “comprising”.

As used herein, the term “cationic polymer” means a polymer having a net cationic charge. Polymers containing amine groups or other protonable groups are included in the term “cationic polymers,” wherein the polymer is protonated at the pH of the intended use. As used herein, the term “polymer” includes homopolymer, copolymer or terpolymer and polymers with 4 or more type of monomers.

As used herein, an “effective amount” of a material or composition is the amount needed to accomplish an intended purpose, for example, to impart a desired level of fabric care benefit to a substrate.

As used herein, “fabric treatment and/or care compositions” include fabric care compositions for handwash, machine wash and other purposes including fabric care additive compositions and compositions suitable for use in the soaking and/or pretreatment of fabrics. They make take the form of, for example, laundry detergents, fabric conditioners, and other wash, rinse, dryer added products, sprays, or compositions capable of direct application to a textile. The fabric care compositions may take the form of a granular detergent or dryer added fabric softener sheet. The term includes, unless otherwise indicated, granular or powder-form all-purpose or “heavy-duty” washing agents, especially cleaning detergents; liquid, gel or paste-form all-purpose washing agents; liquid fine-fabric detergents; as well as cleaning auxiliaries such as bleach additives and “stain-stick” or pre-treat types, substrate-laden products such as dryer added sheets, dry and wetted wipes and pads, nonwoven substrates, and sponges; as well as sprays and mists.

As used herein, “treatment and/or care agent” refers to any of the agents defined in the disclosure herein.

As used herein, the terms “include,” “includes,” and “including” are meant to be non-limiting.

As used herein, the term “IV,” or “Iodine Value” is the number of grams of iodine absorbed per 100 grams of the sample material. The IV range represents the degree of unsaturation, and can be measured by standard AOCS methods.

As used herein, the “polydispersity index” is calculated as

$${\sum }_{i} \vert {n}_{i} - < n > \vert \cdot {x}_{i} ,$$

where nᵢ is the degree of polymerization of the single oligomer i, <n> is the average degree of polymerization of the polyglycerol mixture, and xᵢ is the proportion of the oligomer i in the polyglycerol mixture as determined by the GC method described above. For this calculation, the average degree of polymerization <n> is calculated from the hydroxyl value (OHV, in mg KOH/g) according to the formula <n>=(112200−18*OHV)/(74*OHV−56100).

As used herein, the term “situs” includes paper products, fabrics, garments, and hard surfaces.

As used herein, “stable” means that no visible phase separation is observed for a period of at least about two weeks, or at least about four weeks, or greater than about a month or greater than about four months, as measured using the Floc Formation Test, described in USPA 2008/0263780 A1.

As used herein, “unit dose” means an amount of fabric care composition suitable to treat one load of laundry, such as from about 0.05 g to about 100 g, from 10 g to about 60 g, or from about 20 g to about 40 g.

As used herein, the term “% esterification,” means the percent or average percent of the total OH groups (represented by, for example, “OR” in Formula I) on the polyglycerol that are esterified. In calculating the % esterification, the total amount of OH groups is assumed to be based on a value of “n+3” with “n” the average degree of oligomerization for the polyglycerols as described above and in Formula 1.

As used herein, “% cyclic” means the percent of PGE's having a cyclic group.

Unless otherwise noted, all component or composition levels are in reference to the active portion of that component or composition, and are exclusive of impurities, for example, residual solvents or by-products, which may be present in commercially available sources of such components or compositions.

All percentages and ratios are calculated by weight unless otherwise indicated. All percentages and ratios are calculated based on the total composition unless otherwise indicated.

It should be understood that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

Various uses for polyglycerol esters (“PGEs”) are known. See, for example, U.S. Pat. No. 4,214,038 and US 2006/0276370. PGEs are esters typically obtained by reacting polyglycerol and a fatty acid. Polyglycerols may be prepared from glycerin as described in the literature, for example, as described in U.S. Pat. No. 6,620,904. The use of polyglycerol esters in fabric softening applications has been described for example in JP3886310 which claims a fiber softening agent comprising a mixture of polyglycerol fatty acid ester and sucrose fatty acid ester.

Polyglycerol esters of mixtures mono- and bifunctional carboxylic acids are known per se: U.S. Pat. No. 2,284,127 describes polyglycerol esters obtainable by esterification of 3 to 15 parts of a dicarboxylic acid, 20 to 40 parts of polyglycerol, and 45 to 75 parts of certain fatty acids and the use thereof as a emulsifier and wetting agent. U.S. Pat. No. 6,242,499 describes polyglycerol partial esters comprising the esterification product of a polyglycerol mixture; saturated or unsaturated, linear or branch fatty acids having 12-22 carbon atoms; and dimer acids obtained by dimerization of fatty acids from vegetable oils having a mean functionality of from 2 to 2.4, wherein the overall degree of esterification of the polyglycerol mixture is between 30% and 75%, and wherein the degree of esterification of the polyglycerol mixture with the dimer acids is between 5% and 50%, the preparation of these polyglycerol partial esters and their use as W/O emulsifiers in cosmetic or pharmaceutical preparations and as auxiliaries for dispersing inorganic micropigments in oil dispersions. US20050031580 describes polyglycerol partial esters of polyhydroxystearic acid and polyfunctional carboxylic acids which are obtainable by esterification of a polyglycerol mixture with polyhydroxystearic acid and dimer fatty acids, the degree of esterification of the polyglycerol mixture being between 20 and 75% and their use as W/O emulsifiers in cosmetic or pharmaceutical preparations and as auxiliaries for dispersing inorganic micropigments in oil dispersions.

In general, oligomerization of the glycerol unit is an intermolecular reaction between two glycerin molecules to form a diglycerol. Two such oligomers can also be reacted together, or an oligomer can be reacted with an additional glycerin to form yet higher oligomers. Polyglycerols may be converted to polyglycerol esters by typical esterification techniques for example, via reaction with fatty acids, fatty acid chlorides, and the like. The fatty acids used in the esterification can be a mixture of fatty acid chain lengths such as, for example, the fatty acid mixtures derived from coconut oil or tallow. The fatty acids may be saturated or unsaturated, and may contain from about 12 to about 22 carbon atoms, or about 10 to 22 carbon atoms. The fatty acid mixtures derived from natural fats and oils such as, for example, rapeseed oil, peanut oil, lard, tallow, coconut oil, soybean oil can be converted to saturated form by hydrogenation, such processes being readily understood by one of ordinary skill in the art.

Applicants have recognized that by judiciously selecting fatty acid length, the average degree of esterification, the average degree of saturation, the average number of polyglycerol units (oligomerization) in a PGE and the degree of cross-linking. Applicants have recognized that cross-linked PGE molecules may have improved properties, for example, improved softening, viscosity, biodegradability, or performance.

In another aspect, Applicants have recognized that the combination of the PGEs disclosed herein and a silicone material may result in a synergistic benefit with respect to feel of a fabric. While silicone materials can be used as a lubricant on a fabric surface, inclusion of silicones, in some instances, may result in reduced body/fluffiness of the fabric, particularly when applied to terry towels. The combination of the PGE and silicones, in contrast, provide a smooth surface with increased body to provide a smooth fluffy soft feel benefit. Applicants have further recognized that the inclusion of silicones with the disclosed PGEs results in compositions having a more desirable viscosity.

Applicants have further recognized that there are differences in water solubility among PGEs influence desirability of use. For example, solubilities for monoester diglycerols and higher glycerols are significantly greater than what may be suitable for a composition in which PGE deposition may be desired. In contrast, the corresponding diester solubilities are several orders of magnitude lower and significantly less than typical in wash (or in rinse) concentrations. As such, the monoesters are disfavored where efficient deposition of the PGE may be desired.

It has now been found, surprisingly, that the novel polyglycerol partial esters of claim 1 fulfill the requirements. The present invention therefore relates to fabric and household hard surface treatment compositions comprising a mixture of polyglycerol partial esters having the structure of Formula (I)

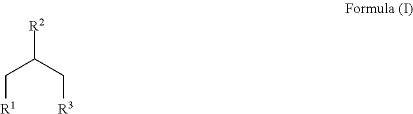

with R¹, R² and R³ independent from each other, equal or different selected from the group consisting of
—OH,
—OR⁴, with R⁴ a linear, unsubstituted acyl radical with a chain length of from 16 to 22 carbon atoms with the proviso that the monocarboxylic acids obtained from the acyl radical by saponification bears an iodine value of smaller than 50, a radical having the structure of general Formula (II)

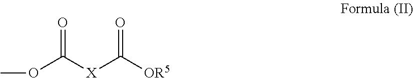

with R⁵ a radical having the structure of Formula (I) wherein one of R¹, R² and R³ being a direct bond to the oxygen of —OR⁵ and with X a bivalent organic residue with from 2 to 34 carbon atoms and
—OR⁵, with R⁵ like above

wherein each molecule of the polyglycerol partial ester comprises at least one of each —OR⁵ and a radical having the structure of Formula (II), with the provisos that the polyglycerol partial ester comprises an HLB-value from 2 to 10 and that the polyglycerol obtained by hydrolysis of the polyglycerol partial ester comprises an average degree of condensation of from 2 to 8 and at least 1% of the polyglycerol comprises cyclic structures.

The invention also relates to the use of the polyglycerol partial esters according to the invention in fabric softeners and fabric softeners comprising polyglycerol partial esters according to the invention.

An advantage of the present invention is that the polyglycerol partial esters according to the invention have excellent emulsifying properties. A further advantage of the present invention is that the formulation comprising the polyglycerol partial esters according to the invention are stable at high temperature. Yet a further advantage of the present invention is that the polyglycerol partial esters according to the invention have a viscosity increasing effect in formulations. Yet a further advantage of the present invention is that the polyglycerol partial esters according to the invention have an enhanced deposition in the presence of an anionic surfactant. Another advantage is, that the polyglycerol partial esters according to the invention are biodegradable and have a low human and environmental toxicity. Yet another advantage is that the polyglycerol partial esters according to the invention are stable had neutral pH allowing for formulation with material that are not stable at low pH such as enzymes and certain perfumes. Another advantage is, that the polyglycerol partial esters according to the invention provide improved static control over other non-ionic softeners.

The person skilled in the art will acknowledge that polyglycerol esters due to their polymeric nature and due to the methods they are prepared by are statistical mixtures of different structures. Thus, a polyglycerol molecule may comprise ether bonds between two primary positions, a primary and a secondary position, or two secondary positions of the glycerol monomer units. Cyclic structures comprising one or more cycles may also be present. For tetraglycerol and higher oligomers, branched structures comprising at least one glycerol monomer unit linked to three further glycerol monomer units via an ether linkage may be present. A polyglycerol mixture may contain different oligomers and isomers of these, and may be characterized by the oligomer distribution, i. e. the proportion of mono-, di-, tri-, . . . -glycerol structures in the mixture. This distribution can for example be determined by high temperature gas chromatography of the polyglycerol mixture after derivatization. Synthesis of single oligoglycerol isomers is described in “Original synthesis of linear, branched and cyclic oligoglycerol standards”, Cassel et al., Eur. J. Org. Chem. 2001, 875-896.

Additionally, the esterification of polyglycerol mixtures typically results in a distribution of non-esterified polyglycerol, monoester, diester, triester, etc., where the average degree of esterification is determined by the ratio of fatty acid (or its derivative) to polyglycerol used in the synthesis. If a mixture of different fatty acids is used for the esterification, more than one equal or different fatty acid residues may be linked to one polyglycerol molecule via ester linkage.

Additional esterification with dicarboxylic acids results in oligomerization or cross-linking of the polyglycerol ester substructures. The oligomers or polymers thus formed may be linear polyesters of the general structure A(BA)ₙ or B(AB)ₙ, where A is a polyglycerol or polyglycerol fatty acid ester moiety, and B is a dicarboxylic acid moiety, but may also comprise branched or multi-branched structures. The average degree of polymerization of the polyester is determined by the ratio or polyglycerol fatty acid ester and dicarboxylic acid (or its derivative) in the esterification process.

For the present invention it is essential that the hydrophilic-lipophilic balance value (HLB value) of the mixture of polyglycerol partial esters is between 2 and 10. The HLB value is a measure of the degree to which the molecule is hydrophilic or lipophilic, determined by calculating values for the different regions of the molecule. For the purpose of the present invention, the HLB value of the polyglycerol partial esters is calculated as follows:

HLB=(mp/(mp+ma))*20,

where mp is the mass of polyglycerol, and ma is the mass of carboxylic acid mixture (comprising mono- and dicarboxylic acid) used in the synthesis of the polyglycerol ester. For example, esterification of 100 g polyglycerol with 90 g monocarboxylic acid and 10 g dicarboxylic acid would result in an HLB of (100 g/(90 g+10 g+100 g))*20=10, independent of the degree of polymerization of the polyglycerol and the type of carboxylic acids used.

For the present invention it is essential that the polyglycerol backbone of the polyglycerol partial ester comprises an average degree of condensation of from 2 to 8, preferred from 2.5 to 6, particularly preferred from 3 to 4.5. A suitable method for determining the mean degree of condensation of the polyglycerol in a given polyglycerol partial ester comprises hydrolysis of the partial ester, separation of the resulting polyglycerol from the formed carboxylic acid compounds, and analysis by gas chromatography after derivatization.

Polyglycerol depending on its way of preparation can comprise different percentages of cyclic structures. An overview of some cyclic structures present in commercial polyglycerol mixtures is given in “Original synthesis of linear, branched and cyclic oligoglycerol standards”, Cassel et al., Eur. J. Org. Chem. 2001, 875-896. For the polyglycerol partial esters it is essential, that the polyglycerol in the polyglycerol backbone of the partial ester comprises at least 1%, preferably at least 2% and even more preferred at least 3% cyclic structures.

The given percentages are neither percentages by weight nor per mole but are determined with a methodology which is:

It is advantageous if the polyglycerol partial esters comprise a polyglycerol backbone in that the polyglycerol comprises a polydispersity index of greater than 0.75. For the purpose of the present invention, the polydispersity index is calculated as

$${\sum }_{i} \vert {n}_{i} - < n > \vert \cdot {x}_{i} ,$$

where nᵢ is the degree of polymerization of the single oligomer i, <n> is the average degree of polymerization of the polyglycerol mixture, and xᵢ is the proportion of the oligomer i in the polyglycerol mixture as determined by the GC method described above. For this calculation, the average degree of polymerization <n> is calculated from the hydroxyl value (OHV, in mg KOH/g) according to the formula

<n>=(112200−18*OHV)/(74*OHV−56100).

The radicals R⁵ in the polyglycerol partial ester might be the same or different within one molecule, preferably they are different. It is obvious, that the residue.

—OR⁴ is determined by the monocarboxylic acid HOR⁴ used in the esterification reaction for preparing the polyglycerol partial ester. Preferred residues —OR⁴ are accordingly derived from the acids selected from the group consisting of palmitic acid, stearic acid, arachidic acid, and behenic acid. Mixtures of different acids can be used, too, especially technical mixtures like for example fully or partially hydrogenated palm fatty acids, palm kernel fatty acids, coconut fatty acids, soybean fatty acids, tallow fatty acids, rapeseed fatty acids, high erucic rapeseed fatty acids or distilled fractions of these as long as their iodine value is smaller than 50, preferred smaller than 30 and more preferred smaller than 25. Depending on the degree of hydrogenation and the raw material, these technical mixtures can contain certain amounts of unsaturated fatty acids which then are contained in the polyglycerol partial ester according to the invention. Typical examples of these unsaturated fatty acids are palmitoleic acid, oleic acid, elaidic acid, erucic acid, linoleic acid, and linolenic acid, where oleic acid and elaidic acid are most commonly found as constituents of partially hydrogenated fatty acid mixtures. The amount of this byproduct can be determined by the iodine value of the fatty acids obtained from the acyl radical by saponification of the polyglycerol partial ester. It is essential to the polyglycerol partial ester of the present invention, that this iodine value is smaller than 50, more preferred smaller than 30 and even more preferred from 1 to 25. The iodine value can be determined by DIN 53241-1:1995-05.

It is also obvious, that the radical having the structure of general Formula (II) is derived from a dicarboxylic acid having the structure of general Formula (IIb).

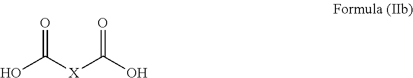

In a preferred embodiment the radical of Formula (II) is derived from the group of dicarboxylic acids known as dimer fatty acids. The dimer fatty acids employed are a mix of acyclic and cyclic dicarboxylic acids which are obtained by a catalysed dimerization of unsaturated fatty acids having 12 to 22 C atoms and have an average functionality of 2 to 3, preferably approximately 2. They can also comprise polymeric fatty acids (trimeric and of higher functionality) in a minor amount. The acid numbers are in the range from 150 to 290, preferably 190 to 200. Commercially available products have on average monomer contents of approximately 7 to 15 wt. %, dimer contents of approximately 70 to 77 wt. % and polymer contents of approximately 15 to 16 wt. %. They can be adjusted to higher contents of the particular functionalities (mono, di, tri) by known separation processes and/or to low contents of unsaturated fatty acids (low iodine numbers) by hydrogenation. Further information is to be found in the products sheets of the manufacturers, such as, for example, of Croda/Uniqema (Pripol®) and Arizona Chem. (Unidyme®, Century®). For the preparation and use of dimer acids and the physical and chemical properties thereof, reference is also made to the publication “The Dimer Acids: The chemical and physical properties, reactions and applications”, ed. E. C. Leonard; Humko Sheffield Chemical, 1975, Memphis, Tenn. The content of the aforementioned reference is incorporated herein by reference.

The use of relatively short-chain dicarboxylic acids instead of dimer acids, such as succinic acid, maleic acid, fumaric acid, glutaric acid, adipic acid, pimelic acid, suberic acid, azelaic acid, sebacic acid and dodecanedioic acid, is particularly suitable for the intended use according to the invention as fabric softener. Hydroxydicarboxylic acids, such as malic acid and tartaric acid are also suitable. Also suitable are aromatic dicarboxylic acid, in particular phthalic acid, isophthtalic acid, and terephthalic acid. The alkanedicarboxylic acids having 4 to 14 C atoms are particularly preferred.

Preferred polyglycerol partial esters according to the invention therefore are characterized in that X is a bivalent, linear, unsubstituted alkyl radical with 2 to 12 carbon atoms In a preferred embodiment the molar ratio of monocarboxylic acid components to dicarboxylic acid components is 2-20, preferably 2.5-10, more preferably 3-8.

Also preferred are polyglycerol partial esters according to the invention which have a molecular weight (number averaged molecular weight Mn by gel permeation chromatography) of at least 2000 g/mol, preferably at least 2400 g/mol, more preferably at least 2700 g/mol. Obviously, the molecular weight of the polyglycerol ester can be increased by increasing degree of polymerization of the polyglycerol, degree of esterification with monocarboxylic acid(s), degree of esterification with dicarboxylic acid(s), or more than one of these parameters at the same time.

Preferably polyglycerol partial esters according to the invention are characterized in that the molar ratio of the monocarboxylic acid component to the dicarboxylic acid component is 2-20, preferably 2.5-10, more preferably 3-8.

Preferred polyglycerol partial esters according to the invention are characterized in that they have a melting point of at least 25° C., preferably of at least 35° C., more preferably of at least 40° C.

The partial esters according to the present invention are obtainable by a process of esterification of

a) a polyglycerol mixture comprising an average degree of condensation of from 2 to 8 and at least 1% of cyclic structures, with

b) at least one monocarboxylic acid comprising a carboxylic acid HOR⁴, with R⁴ a linear, unsubstituted acyl radical with a chain length of from 16 to 22 carbon atoms with the proviso that the carboxylic acid or mixture of carboxylic acids bears an iodine value of smaller than 50, preferably smaller than 30, particularly preferably smaller than 25,

c) at least one dicarboxylic acid having the structure of general Formula (IIb).

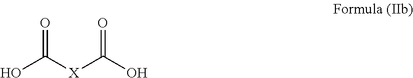

with X a bivalent organic residue with from 2 to 34 carbon atoms

or mixtures thereof

with the provisio that the ratio by weight of polyglycerol mixture to the sum of monocarboxylic acid and dicarboxylic acid is in the range from about 0.11 to 1, preferably in the range from about 0.11 to 0.67.

It is obvious that instead of the monocarboxylic acids b) and the dicarboxylic acids c) suitable derivatives of the carboxylic acids like their anhydrides, their halogenides, and their esters, preferably their esters with short chain alcohols like methanol or ethanol, may be used to obtain the polyglycerol esters according to the invention.

The process of preparing polyglycerol partial ester can be in two stages which proceed in a manner known per se. First the polyglycerol is esterified with the at least one carboxylic acid, in a second step the at least one dicarboxylic acid is added.

Preferred polyglycerols used in the process for obtaining the polyglycerol partial ester according to the present invention comprise an average degree of condensation of 2-8, preferably 2.5-6, particularly preferably 3-4.5.

The polyglycerol used in the esterification process described above can be produced by several methods. Suitable methods for the production of polyglycerol include polymerization of glycidol (e. g. with base catalysis), polymerization of epichlorohydrin (e. g. in the presence of equimolar amounts of a base like NaOH), or polycondensation of glycerol.

The preferred method for the purpose of this invention is condensation of glycerol, in particular in the presence of catalytic amounts of base, preferably NaOH or KOH. Suitable reaction conditions include temperatures of 220-260° C. and reduced pressure (20-800 mbar, preferably 50-500 mbar) to facilitate removal of reaction water from the mixture. The progress of the condensation reaction may be followed by measuring refractive index, viscosity, or hydroxyl value of the reaction product.

A particularly preferred method, which results in a desired broader polydispersity of the product, comprises the steps of
reacting glycerol in a condensation reaction in the presence of a catalytic amount (0.2-5% by weight) of base at a temperature from about 220-260° C. at a pressure between 250 and 1000 mbar while removing reaction water by distillation until the reaction mixture contains less than 70% (preferably less than 60%) of glycerol
continuing the condensation reaction at a lower pressure between 20 and 200 mbar while removing reaction water and glycerol by distillation until the hydroxyl value of the reaction mixture is lower than 1400 (preferably lower than 1200), and
optionally neutralizing the catalyst with an acid.

The crosslinked polyglycerol esters may also be obtained by a process of esterification of

a) a polyglycerol mixture that may comprise an average degree of condensation of from about 2 to about 8 and at least 1% of cyclic structures, with

b) at least one non crosslinker moiety that may comprise a monocarboxylic acid having a linear, unsubstituted acyl radical with a chain length of from about 16 to about 22 carbon atoms with the proviso that the carboxylic acid or mixture of carboxylic acids bears an iodine value of less than about 50, or less than about 30, or less than about 25,

c) at least one crosslinker moiety comprising a dicarboxylic acid having the general structure of

HO—C(O)—(CH₂)ₓ—C(O)O—H.

wherein X may be from about 2 to about 34, or mixtures thereof,

with the provisio that the ratio by weight of polyglycerol mixture to the sum of monocarboxylic acid and dicarboxylic acid is in the range from about 0.11 to 1 preferably in the range from about 0.11 to 0.67

Instead of the monocarboxylic acids and the dicarboxylic acids, suitable derivatives of the carboxylic acids such as anhydrides, halogenides, and esters, in one aspect esters with short chain alcohols such as methanol or ethanol, may be used to obtain the polyglycerol esters disclosed herein.

In one aspect, the polyglycerol partial esters may comprise a polyglycerol backbone wherein said polyglycerol may comprise a polydispersity index of greater than about 60.

The process of preparing polyglycerol partial ester may be in two stages. First the polyglycerol may be esterified with the at least one carboxylic acid. In a second step, the at least one dicarboxylic acid may be added.

Preferred polyglycerols used in the process for obtaining the polyglycerol partial ester disclosed herein may comprise an average degree of condensation of from about 2 to about 8, or from about 2.5 to about 6, or from about 3 to about 4.5.

The polyglycerol used in the esterification process described above may be produced by several methods. Suitable methods for the production of polyglycerol may include polymerization of glycidol (e. g. with base catalysis), polymerization of epichlorohydrin (e. g. in the presence of equimolar amounts of a base like NaOH), and/or polycondensation of glycerol.

In one aspect, the polyglycerol ester may be obtained via condensation of glycerol, such as in the presence of catalytic amounts of base. In one aspect, such base may be NaOH or KOH. The reactions may be carried out at temperatures of from about 220 to about 260° C. and reduced pressure (such as from about 20 to about 800 mbar, or in one aspect, from about 50 to about 500 mbar) to facilitate removal of reaction water from the mixture. The progress of the condensation reaction may be followed by measuring refractive index, viscosity, or hydroxyl value of the reaction product.

### COMPARATIVE EXAMPLE 1

### Preparation of [PGE 15] (Branched FA)

Fatty acid type: Branched, saturated C18, Iodine value<5

Dicarboxylic acid: Dimer acid

Molar ratio monoacid:diacid 3.6

Average DP of polyglycerol: 3.2 (OHV 1150)

Cyclics content: 1.5% (GC peak area)

Polydispersity index of polyglycerol: 0.7

HLB: 4.4

EER: 6.65

Panel: −

### COMPARATIVE EXAMPLE 2

### Preparation of [PGE 16] (Branched FA)

Fatty acid type: mixture of branched, saturated C18, Iodine value<5, and polyhydroxystearic acid

Dicarboxylic acid: Sebacic acid

Molar ratio monoacid:diacid 5.1

Average DP of polyglycerol: 4.2 (OHV 1055)

Cyclics content: 1.1% (GC peak area)

Polydispersity index of polyglycerol: 1.5

HLB: 4.4

EER: 9.90

Panel: −

### COMPARATIVE EXAMPLE 3

### Preparation of [PGE 3] (Without Dicarboxylic Acid)

Fatty acid type: IV 20, 30% C16, 65% C18

Dicarboxylic acid: none

Molar ratio monoacid:diacid not relevant

Average DP of polyglycerol: 3.2 (OHV 1150)

Cyclics content: 1.5% (GC peak area)

Polydispersity index of polyglycerol: 0.7

HLB: 6.1

EER: 11.6

Panel: −

### EXAMPLE 1

### Preparation of [PGE 37]

Fatty acid type: IV 20, 30% C16, 65% C18

Dicarboxylic acid: Sebacic acid

Molar ratio monoacid:diacid 4.0

Average DP of polyglycerol: 3.2 (OHV 1150)

Cyclics content: 1.5% (GC peak area)

Polydispersity index of polyglycerol: 0.8

HLB: 5.4

EER: 22.2

Panel: ++

### EXAMPLE 2

### Preparation of [PGE 38]

Fatty acid type: IV 20, 30% C16, 65% C18

Dicarboxylic acid: Sebacic acid

Molar ratio monoacid:diacid 3.1

Average DP of polyglycerol: 3.2 (OHV 1150)

Cyclics content: 1.5% (GC peak area)

Polydispersity index of polyglycerol: 0.8

HLB: 5.2

EER: 14.6

Panel: ++

### EXAMPLE 3

### Preparation of [PGE 39]

Fatty acid type: IV 20, 30% C16, 65% C18

Dicarboxylic acid: Sebacic acid

Molar ratio monoacid:diacid 3.0

Average DP of polyglycerol: 3.2 (OHV 1150)

Cyclics content: 1.5% (GC peak area)

Polydispersity index of polyglycerol: 0.8

HLB: 5.1

EER: 16.0

Panel: +++

### EXAMPLE 4

### Preparation of [PGE 58]

Fatty acid type: IV 20, 30% C16, 65% C18

Dicarboxylic acid: Sebacic acid

Molar ratio monoacid:diacid 7.0

Average DP of polyglycerol: 3.4 (OHV 1120)

Cyclics content: 6.9% (GC peak area)

Polydispersity index of polyglycerol: 1.4

HLB: 3.7

EER: 24.3

Panel: ++

### EXAMPLE 5

### Preparation of [PGE 59]

Fatty acid type: IV 20, 30% C16, 65% C18

Dicarboxylic acid: Sebacic acid

Molar ratio monoacid:diacid 6.0

Average DP of polyglycerol: 3.4 (OHV 1120)

Cyclics content: 6.9% (GC peak area)

Polydispersity index of polyglycerol: 1.4

HLB: 4.1

EER: 18.6

Panel: ++

### EXAMPLE 6

### Preparation of [PGE 60]

Fatty acid type: IV 20, 30% C16, 65% C18

Dicarboxylic acid: Sebacic acid

Molar ratio monoacid:diacid 4.6

Average DP of polyglycerol: 3.4 (OHV 1120)

Cyclics content: 6.9% (GC peak area)

Polydispersity index of polyglycerol: 1.4

HLB: 4.0

EER: 20.8

Panel: +++

### EXAMPLE 7

### Preparation of [PGE 61]

Fatty acid type: IV 20, 30% C16, 65% C18

Dicarboxylic acid: Dimer acid

Molar ratio monoacid:diacid 6.0

Average DP of polyglycerol: 3.4 (OHV 1120)

Cyclics content: 6.9% (GC peak area)

Polydispersity index of polyglycerol: 1.4

HLB: 3.5

EER: 20.3

Panel: +

The compositions of the present invention may include a variety of fabric care compositions, such as, for example, fabric enhancer compositions in which a feel benefit, such as softening benefit, is desired. Suitable “treatment and/or care agents” include any known material suitable for the treatment or care of fabrics or other situs, for example, polymers, including cationic polymers, surfactants, builders, chelating agents, dye transfer inhibiting agents, dispersants, enzymes, and enzyme stabilizers, catalytic materials, bleach activators, polymeric dispersing agents, clay soil removal/anti-redeposition agents, brighteners, suds suppressors, dyes, perfume and/or perfume delivery systems, structure elasticizing agents, fabric softeners, carriers, hydrotropes, processing aids and/or pigments.

In one aspect, the composition may comprise an emulsifier. Said emulsifier may be selected from the group consisting of cationic surfactants, anionic surfactants, nonionic surfactants, and mixtures thereof.

In one aspect, the compositions may have a pH from about 2 to about 11, or from about 2 to about 9.5, or from about 2 to about 5. In one aspect, the composition may have a pH from about 2.5 to about 4. In one aspect, the composition is stable at a pH of from about 5.5 to about 8.

In one aspect, the treatment and/or care agent may be selected from the group consisting of organosilicones, quaternary ammonium compounds, and combinations thereof.

In one aspect, the treatment and/or care agent may comprise an organosilicone. Suitable organosilicones comprise Si—O moieties and may be selected from (a) non-functionalized siloxane polymers, (b) functionalized siloxane polymers, and combinations thereof. The molecular weight of the organosilicone is usually indicated by the reference to the viscosity of the material. In one aspect, the organosilicones may comprise a viscosity of from about 10 to about 2,000,000 centistokes at 25° C. In another aspect, suitable organosilicones may have a viscosity of from about 10 to about 800,000 centistokes at 25° C.

Suitable organosilicones may be linear, branched or cross-linked. In one aspect, the organosilicones may be linear.

In one aspect, the organosilicone may comprise a non-functionalized siloxane polymer that may have Formula I below, and may comprise polyalkyl and/or phenyl silicone fluids, resins and/or gums.

[R₁R₂R₃SiO_{1/2}]ₙ[R₄R₄SiO_{2/2}]ₘ[R₄SiO_{3/2}]ⱼ (Formula I)

wherein:

i) each R₁, R₂, R₃ and R₄ may be independently selected from the group consisting of H, —OH, C₁-C₂₀ alkyl, C₁-C₂₀ substituted alkyl, C₆-C₂₀ aryl, C₆-C₂₀ substituted aryl, alkylaryl, and/or C₁-C₂₀ alkoxy, moieties;

ii) n may be an integer from about 2 to about 10, or from about 2 to about 6; or 2; such that n=j+2;

iii) m may be an integer from about 5 to about 8,000, from about 7 to about 8,000 or from about 15 to about 4,000;

iv) j may be an integer from about 0 to about 10, or from about 0 to about 4, or 0;

In one aspect, R₂, R₃ and R₄ may comprise methyl, ethyl, propyl, C₄-C₂₀ alkyl, and/or C₆-C₂₀ aryl moieties. In one aspect, each of R₂, R₃ and R₄ may be methyl. Each R₁ moiety blocking the ends of the silicone chain may comprise a moiety selected from the group consisting of hydrogen, methyl, methoxy, ethoxy, hydroxy, propoxy, and/or aryloxy.

As used herein, the nomenclature SiO“n”/2 represents the ratio of oxygen and silicon atoms. For example, SiO_{1/2} means that one oxygen is shared between two Si atoms. Likewise SiO_{2/2} means that two oxygen atoms are shared between two Si atoms and SiO_{3/2} means that three oxygen atoms are shared are shared between two Si atoms.

In one aspect, the organosilicone may be polydimethylsiloxane, dimethicone, dimethiconol, dimethicone crosspolymer, phenyl trimethicone, alkyl dimethicone, lauryl dimethicone, stearyl dimethicone and phenyl dimethicone. Examples include those available under the trade names DC 200 Fluid, DC 1664, DC 349, DC 346G available from offered by Dow Corning Corporation, Midland, Mich., and those available under the trade names SF1202, SF1204, SF96, and Viscasil® available from Momentive Silicones, Waterford, N.Y.

In one aspect, the organosilicone may comprise a cyclic silicone. The cyclic silicone may comprise a cyclomethicone of the formula [(CH₃)₂SiO]ₙ where n is an integer that may range from about 3 to about 7, or from about 5 to about 6.

In one aspect, the organosilicone may comprise a functionalized siloxane polymer. Functionalized siloxane polymers may comprise one or more functional moieties selected from the group consisting of amino, amido, alkoxy, hydroxy, polyether, carboxy, hydride, mercapto, sulfate phosphate, and/or quaternary ammonium moieties. These moieties may be attached directly to the siloxane backbone through a bivalent alkylene radical, (i.e., “pendant”) or may be part of the backbone. Suitable functionalized siloxane polymers include materials selected from the group consisting of aminosilicones, amidosilicones, silicone polyethers, silicone-urethane polymers, quaternary ABn silicones, amino ABn silicones, and combinations thereof.

In one aspect, the functionalized siloxane polymer may comprise a silicone polyether, also referred to as “dimethicone copolyol.” In general, silicone polyethers comprise a polydimethylsiloxane backbone with one or more polyoxyalkylene chains. The polyoxyalkylene moieties may be incorporated in the polymer as pendent chains or as terminal blocks. Such silicones are described in USPA 2005/0098759, and U.S. Pat. Nos. 4,818,421 and 3,299,112. Exemplary commercially available silicone polyethers include DC 190, DC 193, FF400, all available from Dow Corning Corporation, and various Silwet surfactants available from Momentive Silicones.

In another aspect, the functionalized siloxane polymer may comprise an aminosilicone. Suitable aminosilicones are described in U.S. Pat. Nos. 7,335,630 B2, 4,911,852, and USPA 2005/0170994A1. In one aspect the aminosilicone may be that described in USPA 61/221,632. In one aspect, the aminosilicone may comprise the structure of Formula II:

[R₁R₂R₃SiO_{1/2}]ₙ[(R₄Si(X—Z)O_{2/2}]ₖ[R₄R₄SiO_{2/2}]ₘ[R₄SiO_{3/2}]ⱼ (Formula II)
wherein
i. R₁, R₂, R₃ and R₄ may each be independently selected from H, OH, C₁-C₂₀ alkyl, C₁-C₂₀ substituted alkyl, C₆-C₂₀ aryl, C₆-C₂₀ substituted aryl, alkylaryl, and/or C₁-C₂₀ alkoxy;
ii. Each X may be independently selected from a divalent alkylene radical comprising 2-12 carbon atoms, —(CH₂)s- wherein s may be an integer from about 2 to about 10; —CH₂—CH(OH)—CH₂—; and/or

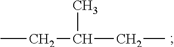

iii. Each Z may be independently selected from —N(R₅)₂; —N(R₅)₃A⁻,

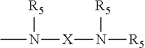

or

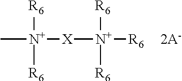

and/or

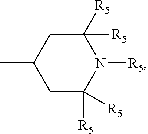

wherein each R₅ may be selected independently selected from H, C₁-C₂₀ alkyl, C₁-C₂₀ substituted alkyl, C₆-C₂₀ aryl, C₆-C₂₀ and/or substituted aryl, each R₆ may be independently selected from H, OH, C₁-C₂₀ alkyl, C₁-C₂₀ substituted alkyl, C₆-C₂₀ aryl, C₆-C₂₀ substituted aryl, alkylaryl, and/or C₁-C₂₀ alkoxy; and A⁻ may be a compatible anion. In one aspect, A⁻ may be a halide;
iv. k may be an integer from about 3 to about 20, or from about 5 to about 18 more or from about 5 to about 10;
v. m may be an integer from about 100 to about 2,000, or from about 150 to about 1,000;
vi. n may be an integer from about 2 to about 10, or about 2 to about 6, or 2, such that n=j+2; and
vii. j may be an integer from about 0 to about 10, or from about 0 to about 4, or 0;

In one aspect, R₁ may comprise —OH. In this aspect, the organosilicone may be amodimethicone.

Exemplary commercially available aminosilicones include DC 8822, 2-8177, and DC-949, available from Dow Corning Corporation, and KF-873, available from Shin-Etsu Silicones, Akron, Ohio.

In one aspect, the organosilicone may comprise amine ABn silicones and quat ABn silicones. Such organosilicones are generally produced by reacting a diamine with an epoxide. These are described, for example, in U.S. Pat. Nos. 6,903,061 B2, 5,981,681, 5,807,956, 6,903,061 and 7,273,837. These are commercially available under the trade names Magnasoft® Prime, Magnasoft® JSS, Silsoft® A-858 (all from Momentive Silicones).

In another aspect, the functionalized siloxane polymer may comprise silicone-urethanes, such as those described in USPA 61/170,150. These are commercially available from Wacker Silicones under the trade name SLM-21200.

When a sample of organosilicone is analyzed, it is recognized by the skilled artisan that such sample may have, on average, non-integer indices for Formula I and II above, but that such average indice values will be within the ranges of the indices for Formula I and II above.

In one aspect, the treatment and/or care agent may comprise an additional fabric softening compounds. Suitable fabric softening compounds are disclosed in USPA 2004/0204337.

In one aspect, the fabric softening active may comprise a quaternary ammonium compound. In one aspect, the quaternary ammonium compound may comprise a quaternary ammonium compound selected from the group consisting of an ester quaternary ammonium compound, an alkyl quaternary ammonium compound, or mixtures thereof.

In one aspect, the ester quaternary ammonium compound may comprise a mixture of mono- and di-ester quaternary ammonium compound. Those skilled in the art will recognize that cationic softening compounds can be selected from mono-, di-, and tri-esters, as well as other cationic softening compounds, and mixtures thereof, depending on the process and the starting materials, and that cationic softening compounds can be selected from tertiary ammonium compounds, as well as other cationic softening compounds, and mixtures thereof. Additional suitable fabric softening compounds are disclosed in USPA 2004/0204337. In one aspect, the composition may comprise a biodegradable quaternary ammonium compound. In one aspect, the composition may comprise a biodegradable quaternary ammonium compound and a biodegradable PGE in a chemically stable matrix.

In one aspect, the composition may comprise a quaternary ammonium composition having from about 0.1% to about 30% of mono-ester quaternary ammonium, or from about 0.5% to about 20% of mono-ester quaternary ammonium, by weight of fabric enhancer, or from about 2% to about 12% of mono-ester quaternary ammonium, by weight of the composition.

In one aspect, the composition may comprise from about 1%, or from about 2%, or from about 3%, or from about 5%, or from about 10%, or from about 12%, to about 90%, or to about 40%, or to about 30%, or to about 20%, or to about 18%, or to about 15%, of said quaternary ammonium compound, by weight of the composition.

In one aspect, the composition may comprise a PGE and a quaternary ammonium compound at a ratio of from about 100:1 to about 1:1, or about 20:1 to about 1:1, or about 10:1 to about 1:1. In one aspect, the amount of quaternary ammonium compound may exceed the amount of PGE in the composition.

In one aspect, the composition comprising the PGE and the quaternary ammonium compound may have a pH from about 2.5 to about 4.

In one aspect, the treatment and/or care agent may comprise a perfume and a cationic polymer.

In one aspect, the treatment and/or care agent may comprise a perfume, and a quaternary ammonium compound.

In yet another aspect, the treatment and/or care agent may comprise a perfume, a cationic polymer and a quaternary ammonium compound.

Additional Treatment and/or Care Agents—While not essential, the non-limiting list of materials illustrated hereinafter are suitable for use in the instant compositions and may be desirably incorporated in certain aspects, for example to assist or enhance cleaning performance, for treatment of the substrate to be cleaned, or to modify the aesthetics of the cleaning composition as may be the case with perfumes, colorants, or the like. The precise nature of these additional components, and levels of incorporation thereof, will depend on the physical form of the composition and the nature of the cleaning operation for which it is to be used. Suitable adjunct materials include, but are not limited to, surfactants, builders, chelating agents, dye transfer inhibiting agents, dispersants, enzymes, and enzyme stabilizers, polymeric dispersing agents, structurants, clay soil removal/anti-redeposition agents, brighteners, suds suppressors, perfumes, structure elasticizing agents, fabric softeners, carriers, hydrotropes, processing aids, solvents and/or pigments.

Certain aspects of Applicants' compositions do not contain one or more of the following materials: bleach activators, surfactants, builders, chelating agents, dye transfer inhibiting agents, dispersants, enzymes, and enzyme stabilizers, catalytic metal complexes, polymeric dispersing agents, clay and soil removal/anti-redeposition agents, brighteners, suds suppressors, dyes, perfumes and/or perfume delivery systems, structure elasticizing agents, fabric softeners, carriers, hydrotropes, processing aids and/or pigments.

The treatment and/or care agents may include those listed below. Suitable examples of such other treatment and/or care agents and levels of use may also be found in U.S. Pat. Nos. 5,576,282, 6,306,812 B1 and 6,326,348 B1:

Surfactants—In one aspect, the fabric care compositions may comprise from about 0.01% to 80% by weight of a surfactant, or about 1% to about 50% of a surfactant. Surfactants utilized can be of the anionic, nonionic, zwitterionic, ampholytic or cationic type or can comprise compatible mixtures of these types. Detergent surfactants useful herein are described in, for example, U.S. Pat. Nos. 3,664,961, 3,919,678, 4,222,905, and 4,239,659. Anionic and nonionic surfactants are useful if the fabric care product is a laundry detergent, for example, those described in U.S. Pat. Nos. 6,020,303 and 6,593,285. Cationic surfactants are generally useful if the fabric care product is a fabric softener.

Anionic Surfactants—Useful anionic surfactants can themselves be of several different types, for example, the water-soluble salts, particularly the alkali metal, ammonium and alkylolammonium (e.g., monoethanolammonium or triethanolammonium) salts, of organic sulfuric reaction products having in their molecular structure an alkyl group containing from about 10 to about 20 carbon atoms and a sulfonic acid or sulfuric acid ester group. (Included in the term “alkyl” is the alkyl portion of aryl groups.) Examples of this group of synthetic surfactants are the alkyl sulfates and alkyl alkoxy sulfates, especially those obtained by sulfating the higher alcohols (C₈₋₁₈ carbon atoms).

Other anionic surfactants useful with the compositions described herein are the water-soluble salts of: paraffin sulfonates containing from about 8 to about 24 (alternatively about 12 to 18) carbon atoms; alkyl glyceryl ether sulfonates, especially those ethers of C₈₋₁₈ alcohols (e.g., those derived from tallow and coconut oil); alkyl phenol ethylene oxide ether sulfates containing from about 1 to about 4 units of ethylene oxide per molecule and from about 8 to about 12 carbon atoms in the alkyl group; and alkyl ethylene oxide ether sulfates containing about 1 to about 4 units of ethylene oxide per molecule and from about 10 to about 20 carbon atoms in the alkyl group.

Other useful anionic surfactants herein include the water-soluble salts of esters of α-sulfonated fatty acids. In another aspect, the anionic surfactant may comprise a C₁₁-C₁₈ alkyl benzene sulfonate surfactant; a C₁₀-C₂₀ alkyl sulfate surfactant; a C₁₀-C₁₈ alkyl alkoxy sulfate surfactant, having an average degree of alkoxylation of from 1 to 30, wherein the alkoxy may comprise a C₁ to C₄ chain and mixtures thereof; a mid-chain branched alkyl sulfate surfactant; a mid-chain branched alkyl alkoxy sulfate surfactant having an average degree of alkoxylation of from 1 to 30, wherein the alkoxy may comprise a C₁ to C₄ chain and mixtures thereof; a C₁₀-C₁₈ alkyl alkoxy carboxylates comprising an average degree of alkoxylation of from 1 to 5; a C₁₂-C₂₀ methyl ester sulfonate surfactant, a C₁₀-C₁₈ alpha-olefin sulfonate surfactant, a C₆-C₂₀ sulfosuccinate surfactant, and a mixture thereof.

Nonionic Surfactants—In addition to the anionic surfactant, the fabric care compositions may further contain a nonionic surfactant. The compositions may contain up to about 30%, alternatively from about 0.01% to about 20%, more alternatively from about 0.1% to about 10%, by weight of the composition, of a nonionic surfactant. In one aspect, the nonionic surfactant may comprise an ethoxylated nonionic surfactant. Examples of suitable non-ionic surfactants are provided in U.S. Pat. No. 4,285,841, Barrat et al, issued Aug. 25, 1981. Suitable for use herein are the ethoxylated alcohols and ethoxylated alkyl phenols of the formula R(OC₂H₄)ₙOH, wherein each R may be independently selected from the group consisting of aliphatic hydrocarbon radicals containing from about 8 to about 15 carbon atoms and alkyl phenyl radicals in which the alkyl groups contain from about 8 to about 12 carbon atoms, and the average value of n may be from about 5 to about 15. Additional non-limiting examples are disclosed in U.S. Pat. No. 2,965,576 and U.S. Pat. No. 2,703,798.

Cationic Surfactants—The fabric care compositions may contain up to about 30%, from about 0.01% to about 20%, or from about 0.1% to about 20%, by weight of the composition, of a cationic surfactant. Useful cationic surfactants include those which can deliver fabric care benefits. Non-limiting examples of useful cationic surfactants include: fatty amines; quaternary ammonium surfactants; and imidazoline quat materials.

Amphoteric Surfactants—Non-limiting examples of ampholytic surfactants include: aliphatic derivatives of secondary or tertiary amines, or aliphatic derivatives of heterocyclic secondary and tertiary amines in which the aliphatic radical can be straight- or branched-chain. One of the aliphatic substituents contains at least about 8 carbon atoms, typically from about 8 to about 18 carbon atoms, and at least one contains an anionic water-solubilizing group, e.g. carboxy, sulfonate, sulfate. See U.S. Pat. No. 3,929,678 for examples of ampholytic surfactants.

Builders—The compositions may comprise one or more detergent builders or builder systems.

Chelating Agents—The compositions herein may also optionally contain one or more copper, iron and/or manganese chelating agents. If utilized, chelating agents will generally comprise from about 0.1% by weight of the compositions herein to about 15%, or even from about 3.0% to about 15% by weight of the compositions herein.

Dye Transfer Inhibiting Agents—The compositions may also include one or more dye transfer inhibiting agents. Suitable polymeric dye transfer inhibiting agents include, but are not limited to, polyvinylpyrrolidone polymers, polyamine N-oxide polymers, copolymers of N-vinylpyrrolidone and N-vinylimidazole, polyvinyloxazolidones and polyvinylimidazoles or mixtures thereof. When present in the compositions herein, the dye transfer inhibiting agents are present at levels from about 0.0001%, from about 0.01%, from about 0.05% by weight of the cleaning compositions to about 10%, about 2%, or even about 1% by weight of the cleaning compositions.

Dispersants—The compositions may also contain dispersants. Suitable water-soluble organic materials are the homo- or co-polymeric acids or their salts, in which the polycarboxylic acid may comprise at least two carboxyl radicals separated from each other by not more than two carbon atoms.

Enzymes—The compositions can comprise one or more detergent enzymes which provide cleaning performance and/or fabric care benefits. Examples of suitable enzymes include, but are not limited to, hemicellulases, peroxidases, proteases, cellulases, xylanases, lipases, phospholipases, esterases, cutinases, pectinases, keratanases, reductases, oxidases, phenoloxidases, lipoxygenases, ligninases, pullulanases, tannases, pentosanases, malanases, β-glucanases, arabinosidases, hyaluronidase, chondroitinase, laccase, and amylases, or mixtures thereof. A typical combination may be a cocktail of conventional applicable enzymes like protease, lipase, cutinase and/or cellulase in conjunction with amylase.

Enzyme Stabilizers—Enzymes for use in compositions, for example, detergents can be stabilized by various techniques. The enzymes employed herein can be stabilized by the presence of water-soluble sources of calcium and/or magnesium ions in the finished compositions that provide such ions to the enzymes.

Catalytic Metal Complexes—Applicants' compositions may include catalytic metal complexes. Suitable catalysts are disclosed, for example, in U.S. Pat. Nos. 4,430,243, 5,576,282, 5,597,936, 5,595,967, 5,597,936, and 5,595,967. Compositions may also include a transition metal complex of a macropolycyclic rigid ligand “MRL”. The compositions and cleaning processes herein can be adjusted to provide on the order of at least one part per hundred million of the benefit agent MRL species in the aqueous washing medium, and may provide from about 0.005 ppm to about 25 ppm, from about 0.05 ppm to about 10 ppm, or even from about 0.1 ppm to about 5 ppm, of the MRL in the wash liquor. Suitable transition-metals in the instant transition-metal bleach catalyst include manganese, iron and chromium. Other suitable MRL's herein are a special type of ultra-rigid ligand that may be cross-bridged such as 5,12-diethyl-1,5,8,12-tetraazabicyclo[6,6,2]hexadecane. Suitable transition metal MRLs may be prepared by known procedures, such as taught, for example, in WO 00/32601, and U.S. Pat. No. 6,225,464.

Fabric Softening Actives—The composition may comprise additional fabric softening actives (FSA) or a mixture of more than one FSAs such as those described in U.S. patent application Ser. No. 11/890,924.

Deposition Aid—In one aspect, the fabric treatment composition may comprise from about 0.01% to about 10%, from about 0.05 to about 5%, or from about 0.15 to about 3% of a deposition aid. Suitable deposition aids are disclosed in, for example, U.S. patent application Ser. No. 12/080,358.

In one aspect, the deposition aid may be a cationic or amphoteric polymer. In one aspect, the deposition aid may be a cationic polymer. Cationic polymers in general and their method of manufacture are known in the literature. In one aspect, the cationic polymer may have a cationic charge density of from about 0.005 to about 23, from about 0.01 to about 12, or from about 0.1 to about 7 milliequivalents/g, at the pH of intended use of the composition. For amine-containing polymers, wherein the charge density depends on the pH of the composition, charge density is measured at the intended use pH of the product. Such pH will generally range from about 2 to about 11, more generally from about 2.5 to about 9.5. Charge density is calculated by dividing the number of net charges per repeating unit by the molecular weight of the repeating unit. The positive charges may be located on the backbone of the polymers and/or the side chains of polymers.

One group of suitable cationic polymers includes those produced by polymerization of ethylenically unsaturated monomers using a suitable initiator or catalyst, such as those disclosed in WO 00/56849 and U.S. Pat. No. 6,642,200.

Suitable polymers may be selected from the group consisting of cationic or amphoteric polysaccharide, polyethylene imine and its derivatives, and a synthetic polymer made by polymerizing one or more cationic monomers selected from the group consisting of N,N-dialkylaminoalkyl acrylate, N,N-dialkylaminoalkyl methacrylate, N,N-dialkylaminoalkyl acrylamide, N,N-dialkylaminoalkylmethacrylamide, quaternized N,N dialkylaminoalkyl acrylate quaternized N,N-dialkylaminoalkyl methacrylate, quaternized N,N-dialkylaminoalkyl acrylamide, quaternized N,N-dialkylaminoalkylmethacrylamide, Methacryloamidopropylpentamethyl-1,3-propylene-2-ol-ammonium dichloride, N,N,N,N′,N′,N″,N″-heptamethyl-N″-3-(1-oxo-2-methyl-2-propenyl)aminopropyl-9-oxo-8-azo-decane-1,4,10-triammonium trichloride, vinylamine and its derivatives, allylamine and its derivatives, vinyl imidazole, quaternized vinyl imidazole and diallyl dialkyl ammonium chloride and combinations thereof, and optionally a second monomer selected from the group consisting of acrylamide, N,N-dialkyl acrylamide, methacrylamide, N,N-dialkylmethacrylamide, C₁-C₁₂ alkyl acrylate, C₁-C₁₂ hydroxyalkyl acrylate, polyalkylene glyol acrylate, C₁-C₁₂ alkyl methacrylate, C₁-C₁₂ hydroxyalkyl methacrylate, polyalkylene glycol methacrylate, vinyl acetate, vinyl alcohol, vinyl formamide, vinyl acetamide, vinyl alkyl ether, vinyl pyridine, vinyl pyrrolidone, vinyl imidazole, vinyl caprolactam, and derivatives, acrylic acid, methacrylic acid, maleic acid, vinyl sulfonic acid, styrene sulfonic acid, acrylamidopropylmethane sulfonic acid (AMPS) and their salts. The polymer may optionally be branched or cross-linked by using branching and crosslinking monomers. Branching and crosslinking monomers include ethylene glycoldiacrylate divinylbenzene, and butadiene. A suitable polyethyleneinine useful herein is that sold under the tradename Lupasol® by BASF, AG, Lugwigschaefen, Germany.

In another aspect, the treatment composition may comprise an amphoteric deposition aid polymer so long as the polymer possesses a net positive charge. Said polymer may have a cationic charge density of about 0.05 to about 18 milliequivalents/g.

In another aspect, the deposition aid may be selected from the group consisting of cationic polysaccharide, polyethylene imine and its derivatives, poly(acrylamide-co-diallyldimethylammonium chloride), poly(acrylamide-methacrylamidopropyltrimethyl ammonium chloride), poly(acrylamide-co-N,N-dimethyl aminoethyl acrylate) and its quaternized derivatives, poly(acrylamide-co-N,N-dimethyl aminoethyl methacrylate) and its quaternized derivative, poly(hydroxyethylacrylate-co-dimethyl aminoethyl methacrylate), poly(hydroxpropylacrylate-co-dimethyl aminoethyl methacrylate), poly(hydroxpropylacrylate-co-methacrylamidopropyltrimethylammonium chloride), poly(acrylamide-co-diallyldimethylammonium chloride-co-acrylic acid), poly(acrylamide-methacrylamidopropyltrimethyl ammonium chloride-co-acrylic acid), poly(diallyldimethyl ammonium chloride), poly(vinylpyrrolidone-co-dimethylaminoethyl methacrylate), poly(ethyl methacrylate-co-quaternized dimethylaminoethyl methacrylate), poly(ethyl methacrylate-co-oleyl methacrylate-co-diethylaminoethyl methacrylate), poly(diallyldimethylammonium chloride-co-acrylic acid), poly(vinyl pyrrolidone-co-quaternized vinyl imidazole) and poly(acrylamide-co-Methacryloamidopropyl-pentamethyl-1,3-propylene-2-ol-ammonium dichloride), Suitable deposition aids include Polyquaternium-1, Polyquaternium-5, Polyquaternium-6, Polyquaternium-7, Polyquaternium-8, Polyquaternium-11, Polyquaternium-14, Polyquaternium-22, Polyquaternium-28, Polyquaternium-30, Polyquaternium-32 and Polyquaternium-33, as named under the International Nomenclature for Cosmetic Ingredients.

In one aspect, the deposition aid may comprise polyethyleneimine or a polyethyleneimine derivative. In another aspect, the deposition aid may comprise a cationic acrylic based polymer. In a further aspect, the deposition aid may comprise a cationic polyacrylamide. In another aspect, the deposition aid may comprise a polymer comprising polyacrylamide and polymethacrylamidoproply trimethylammonium cation. In another aspect, the deposition aid may comprise poly(acrylamide-N-dimethyl aminoethyl acrylate) and its quaternized derivatives. In this aspect, the deposition aid may be that sold under the tradename Sedipur®, available from BTC Specialty Chemicals, a BASF Group, Florham Park, N.J. In a yet further aspect, the deposition aid may comprise poly(acrylamide-co-methacrylamidopropyltrimethyl ammonium chloride). In another aspect, the deposition aid may comprise a non-acrylamide based polymer, such as that sold under the tradename Rheovis® CDE, available from Ciba Specialty Chemicals, a BASF group, Florham Park, N.J., or as disclosed in USPA 2006/0252668.

In another aspect, the deposition aid may be selected from the group consisting of cationic or amphoteric polysaccharides. In one aspect, the deposition aid may be selected from the group consisting of cationic and amphoteric cellulose ethers, cationic or amphoteric galactomanan, cationic guar gum, cationic or amphoteric starch, and combinations thereof

Another group of suitable cationic polymers may include alkylamine-epichlorohydrin polymers which are reaction products of amines and oligoamines with epicholorohydrin, for example, those polymers listed in, for example, U.S. Pat. Nos. 6,642,200 and 6,551,986. Examples include dimethylamine-epichlorohydrin-ethylenediamine, available under the trade name Cartafix® CB and Cartafix® TSF from Clariant, Basle, Switzerland.

Another group of suitable synthetic cationic polymers may include polyamidoamine-epichlorohydrin (PAE) resins of polyalkylenepolyamine with polycarboxylic acid. The most common PAE resins are the condensation products of diethylenetriamine with adipic acid followed by a subsequent reaction with epichlorohydrin. They are available from Hercules Inc. of Wilmington Del. under the trade name Kymene™ or from BASF AG (Ludwigshafen, Germany) under the trade name Luresin™. These polymers are described in Wet Strength resins and their applications edited by L. L. Chan, TAPPI Press (1994), at pp. 13-44.

The cationic polymers may contain charge neutralizing anions such that the overall polymer is neutral under ambient conditions. Non-limiting examples of suitable counter ions (in addition to anionic species generated during use) include chloride, bromide, sulfate, methylsulfate, sulfonate, methylsulfonate, carbonate, bicarbonate, formate, acetate, citrate, nitrate, and mixtures thereof.

The weight-average molecular weight of the polymer may be from about 500 to about 5,000,000, or from about 1,000 to about 2,000,000, or from about 2,500 to about 1,500,000 Daltons, as determined by size exclusion chromatography relative to polyethyleneoxide standards with RI detection. In one aspect, the MW of the cationic polymer may be from about 500 to about 37,500 Daltons.

In one aspect, the composition may comprise an adjunct selected from the group comprising a paraffin or perfume containing microcapsule such as those described in U.S. patent application Ser. Nos. 11/145,904; and 11/706,675; U.S. Pat. No. 4,675,022; JP 7,003,639.

In one aspect, the composition may be in a form selected from the group consisting of solid powder, tablet, liquid, gel, and combinations thereof. In one aspect, the composition may be in a unit dose form selected from the group consisting of a tablet, a pouch, and combinations thereof.

In one aspect, an article comprising the composition described herein is disclosed. The article may be selected from the group consisting of bars, sticks, substrate-laden products such as dryer-added sheets, dry and wetted wipes and pads, non-woven substrates, sponges, containers capable of delivering a spray and/or a mist, and combinations thereof.

In one aspect, a method of treating and/or cleaning a situs comprising the steps of a) optionally washing and/or rinsing said situs; b) contacting said situs with a co-particle and/or the product described herein; and c) optionally, washing and/or rinsing said situs is disclosed. In one aspect, a situs treated with the composition described herein is disclosed.

According to certain embodiments, the compositions comprising the mixture of polyglycerol esters may be any surface treatment or cleaning composition, such as, but not limited to, a fabric care composition, a dish cleaning composition, or a home surface care composition. Examples of treatment and cleaning compositions include, but are not limited to, liquid laundry detergents, solid laundry detergents, laundry soap products, laundry spray treatment products, laundry pre-treatment products, hand dish washing detergents, automatic dishwashing detergents, hard surface cleaning detergents, carpet cleaning detergents, and a household cleaning detergent. Examples of fabric care compositions suitable for the present disclosure include, but are not limited to, liquid laundry detergents, heavy duty liquid laundry detergents, solid laundry detergents, laundry soap products, laundry spray treatment products, laundry pre-treatment products, laundry soak products, heavy duty liquid detergents, and rinse additives. Examples of suitable dish cleaning compositions include, but are not limited to, automatic dishwasher detergents, detergents for hand washing of dishes, liquid dish soap, and solid granular dish soap. Examples of suitable home care compositions include, but are not limited to, rug or carpet cleaning compositions, hard surface cleaning detergents, floor cleaning compositions, window cleaning compositions, toilet and bathroom cleaning compositions, household cleaning detergents, and car washing detergents.

### Liquid Detergent Compositions

The treatment or cleaning compositions herein, such as, but not limited to liquid detergent compositions, may take the form of an aqueous solution or uniform dispersion or suspension of surfactant and water, mixture of polyglycerol esters, and certain optional adjunct ingredients, some of which may normally be in solid form, that have been combined with the normally liquid components of the composition. Suitable surfactants may be anionic, nonionic, cationic, zwitterionic and/or amphoteric surfactants. In one embodiment, the cleaning composition comprises anionic surfactant, nonionic surfactant, or mixtures thereof.

Suitable anionic surfactants may be any of the conventional anionic surfactant types typically used in cleaning compositions, such as liquid or solid detergent products. Such surfactants include the alkyl benzene sulfonic acids and their salts as well as alkoxylated or non-alkoxylated alkyl sulfate materials. Exemplary anionic surfactants are the alkali metal salts of C₁₀-C₁₆ alkyl benzene sulfonic acids, preferably C₁₁-C₁₄ alkyl benzene sulfonic acids. In one aspect, the alkyl group is linear. Such linear alkyl benzene sulfonates are known as “LAS”. Such surfactants and their preparation are described for example in U.S. Pat. Nos. 2,220,099 and 2,477,383. Especially preferred are the sodium and potassium linear straight chain alkylbenzene sulfonates in which the average number of carbon atoms in the alkyl group is from about 11 to 14. Sodium C₁₁-C₁₄, e.g., C₁₂ LAS is a specific example of such surfactants.

Another exemplary type of anionic surfactant comprises ethoxylated alkyl sulfate surfactants. Such materials, also known as alkyl ether sulfates or alkyl polyethoxylate sulfates, are those which correspond to the formula: R′—O—(C₂H₄O)ₙ—SO₃M wherein R′ is a C₈-C₂₀ alkyl group, n is from about 1 to 20, and M is a salt-forming cation. In a specific embodiment, R′ is C₁₀-C₁₈ alkyl, n is from about 1 to 15, and M is sodium, potassium, ammonium, alkylammonium, or alkanolammonium. In more specific embodiments, R′ is a C₁₂-C₁₆, n is from about 1 to 6, and M is sodium.

The alkyl ether sulfates will generally be used in the form of mixtures comprising varying R′ chain lengths and varying degrees of ethoxylation. Frequently such mixtures will inevitably also contain some non-ethoxylated alkyl sulfate materials, i.e., surfactants of the above ethoxylated alkyl sulfate formula wherein n=0. Non-ethoxylated alkyl sulfates may also be added separately to the cleaning compositions of this disclosure and used as or in any anionic surfactant component which may be present. Specific examples of non-alkoxylated, e.g., non-ethoxylated, alkyl ether sulfate surfactants are those produced by the sulfation of higher C₈-C₂₀ fatty alcohols. Conventional primary alkyl sulfate surfactants have the general formula: R″OSO₃⁻M⁺ wherein R″ is typically a linear C₈-C₂₀ hydrocarbyl group, which may be straight chain or branched chain, and M is a water-solubilizing cation. In specific embodiments, R″ is a C₁₀-C₁₅ alkyl, and M is alkali metal, more specifically R″ is C₁₂-C₁₄ and M is sodium.

Specific, nonlimiting examples of anionic surfactants useful herein include: a) C₁₁-C₁₈ alkyl benzene sulfonates (LAS); b) C₁₀-C₂₀ primary, branched-chain and random alkyl sulfates (AS); c) C₁₀-C₁₈ secondary (2,3)-alkyl sulfates having Formulae (V) and (VI):

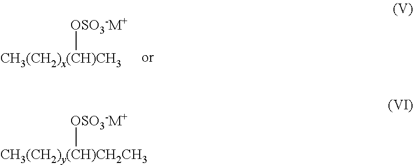

wherein M in Formulae (V) and (VI) is hydrogen or a cation which provides charge neutrality, and all M units, whether associated with a surfactant or adjunct ingredient, can either be a hydrogen atom or a cation depending upon the form isolated by the artisan or the relative pH of the system wherein the compound is used, with non-limiting examples of preferred cations including sodium, potassium, ammonium, and mixtures thereof, and x in Formula V is an integer of at least about 7, preferably at least about 9, and y in Formula VI is an integer of at least 8, preferably at least about 9; d) C₁₀-C₁₈ alkyl alkoxy sulfates (AEₓS) wherein preferably x in Formula V is from 1-30; e) C₁₀-C₁₈ alkyl alkoxy carboxylates preferably comprising 1-5 ethoxy units; f) mid-chain branched alkyl sulfates as discussed in U.S. Pat. Nos. 6,020,303 and 6,060,443; g) mid-chain branched alkyl alkoxy sulfates as discussed in U.S. Pat. Nos. 6,008,181 and 6,020,303; h) modified alkylbenzene sulfonate (MLAS) as discussed in WO 99/05243, WO 99/05242, WO 99/05244, WO 99/05082, WO 99/05084, WO 99/05241, WO 99/07656, WO 00/23549, and WO 00/23548.; i) methyl ester sulfonate (MES); and j) alpha-olefin sulfonate (AOS).

Suitable nonionic surfactants useful herein can comprise any of the conventional nonionic surfactant types typically used in liquid detergent products. These include alkoxylated fatty alcohols and amine oxide surfactants. Preferred for use in the liquid detergent products herein are those nonionic surfactants which are normally liquid. Suitable nonionic surfactants for use herein include the alcohol alkoxylate nonionic surfactants. Alcohol alkoxylates are materials which correspond to the general formula: R⁷(CₘH₂ₘO)ₙOH wherein R⁷ is a C₈-C₁₆ alkyl group, m is from 2 to 4, and n ranges from about 2 to 12. Preferably R⁷ is an alkyl group, which may be primary or secondary, that contains from about 9 to 15 carbon atoms, more preferably from about 10 to 14 carbon atoms. In one embodiment, the alkoxylated fatty alcohols will also be ethoxylated materials that contain from about 2 to 12 ethylene oxide moieties per molecule, more preferably from about 3 to 10 ethylene oxide moieties per molecule.

The alkoxylated fatty alcohol materials useful in the liquid detergent compositions herein will frequently have a hydrophilic-lipophilic balance (HLB) which ranges from about 3 to 17. More preferably, the HLB of this material will range from about 6 to 15, most preferably from about 8 to 15. Alkoxylated fatty alcohol nonionic surfactants have been marketed under the tradename NEODOL® by the Shell Chemical Company.

Another suitable type of nonionic surfactant useful herein comprises the amine oxide surfactants. Amine oxides are materials which are often referred to in the art as “semi-polar” nonionics. Amine oxides have the formula: R′″(EO)ₓ(PO)_{y}(BO)_{z}N(O)(CH₂R′)₂.qH₂O. In this formula, R′″ is a relatively long-chain hydrocarbyl moiety which can be saturated or unsaturated, linear or branched, and can contain from 8 to 20, preferably from 10 to 16 carbon atoms, and is more preferably C₁₂-C₁₆ primary alkyl. R′ is a short-chain moiety, preferably selected from hydrogen, methyl and —CH₂OH. When x+y+z is different from 0, EO is ethyleneoxy, PO is propyleneneoxy and BO is butyleneoxy. Amine oxide surfactants are illustrated by C₁₂-C₁₄ alkyldimethyl amine oxide.

Non-limiting examples of nonionic surfactants include: a) C₁₂-C₁₈ alkyl ethoxylates, such as, NEODOL® nonionic surfactants; b) C₆-C₁₂ alkyl phenol alkoxylates wherein the alkoxylate units are a mixture of ethyleneoxy and propyleneoxy units; c) C₁₂-C₁₈ alcohol and C₆-C₁₂ alkyl phenol condensates with ethylene oxide/propylene oxide block polymers such as PLURONIC® from BASF; d) C₁₄-C₂₂ mid-chain branched alcohols, BA, as discussed in U.S. Pat. No. 6,150,322; e) C₁₄-C₂₂ mid-chain branched alkyl alkoxylates, BAEₓ, wherein x is 1-30, as discussed in U.S. Pat. Nos. 6,153,577; 6,020,303; and 6,093,856; f) alkylpolysaccharides as discussed in U.S. Pat. No. 4,565,647; specifically alkylpolyglycosides as discussed in U.S. Pat. Nos. 4,483,780 and 4,483,779; g) polyhydroxy fatty acid amides as discussed in U.S. Pat. No. 5,332,528; WO 92/06162; WO 93/19146; WO 93/19038; and WO 94/09099; and h) ether capped poly(oxyalkylated) alcohol surfactants as discussed in U.S. Pat. No. 6,482,994 and WO 01/42408.

In the laundry detergent compositions and other cleaning compositions herein, the detersive surfactant component may comprise combinations of anionic and nonionic surfactant materials. When this is the case, the weight ratio of anionic to nonionic will typically range from 10:90 to 90:10, more typically from 30:70 to 70:30.

Cationic surfactants are well known in the art and non-limiting examples of these include quaternary ammonium surfactants, which can have up to 26 carbon atoms. Additional examples include a) alkoxylate quaternary ammonium (AQA) surfactants as discussed in U.S. Pat. No. 6,136,769; b) dimethyl hydroxyethyl quaternary ammonium as discussed in U.S. Pat. No. 6,004,922; c) polyamine cationic surfactants as discussed in WO 98/35002; WO 98/35003; WO 98/35004; WO 98/35005; and WO 98/35006; d) cationic ester surfactants as discussed in U.S. Pat. Nos. 4,228,042; 4,239,660; 4,260,529; and 6,022,844; and e) amino surfactants as discussed in U.S. Pat. No. 6,221,825 and WO 00/47708, specifically amido propyldimethyl amine (APA).

Non-limiting examples of zwitterionic surfactants include: derivatives of secondary and tertiary amines, derivatives of heterocyclic secondary and tertiary amines, or derivatives of quaternary ammonium, quaternary phosphonium or tertiary sulfonium compounds. See U.S. Pat. No. 3,929,678 at column 19, line 38 through column 22, line 48, for examples of zwitterionic surfactants; betaine, including alkyl dimethyl betaine and cocodimethyl amidopropyl betaine, C₈-C₁₈ (preferably C₁₂-C₁₈) amine oxides and sulfo and hydroxy betaines, such as N-alkyl-N,N-dimethylammino-1-propane sulfonate where the alkyl group can be C₈-C₁₈, preferably C₁₀-C₁₄.

Non-limiting examples of ampholytic surfactants include: aliphatic derivatives of secondary or tertiary amines, or aliphatic derivatives of heterocyclic secondary and tertiary amines in which the aliphatic radical can be straight- or branched-chain. One of the aliphatic substituents contains at least about 8 carbon atoms, typically from about 8 to about 18 carbon atoms, and at least one contains an anionic water-solubilizing group, e.g. carboxy, sulfonate, sulfate. See U.S. Pat. No. 3,929,678 at column 19, lines 18-35, for examples of ampholytic surfactants.

The cleaning compositions disclosed herein may be prepared by combining the components thereof in any convenient order and by mixing, e.g., agitating, the resulting component combination to form a phase stable cleaning composition. In one aspect, a liquid matrix is formed containing at least a major proportion, or even substantially all, of the liquid components, e.g., nonionic surfactant, the non-surface active liquid carriers and other optional liquid components, with the liquid components being thoroughly admixed by imparting shear agitation to this liquid combination. For example, rapid stifling with a mechanical stirrer may usefully be employed. While shear agitation is maintained, substantially all of any anionic surfactant and the solid ingredients can be added. Agitation of the mixture is continued, and if necessary, can be increased at this point to form a solution or a uniform dispersion of insoluble solid phase particulates within the liquid phase. After some or all of the solid-form materials have been added to this agitated mixture, particles of any enzyme material to be included, e.g., enzyme prills are incorporated. As a variation of the composition preparation procedure described above, one or more of the solid components may be added to the agitated mixture as a solution or slurry of particles premixed with a minor portion of one or more of the liquid components. After addition of all of the composition components, agitation of the mixture is continued for a period of time sufficient to form compositions having the requisite viscosity and phase stability characteristics. Frequently this will involve agitation for a period of from about 30 to 60 minutes.

In another aspect of producing liquid cleaning compositions, the mixture of polyglycerol esters may first be combined with one or more liquid components to form a mixture of polyglycerol estersmixture of polyglycerol esters premix, and this mixture of polyglycerol estersmixture of polyglycerol esters premix is added to a composition formulation containing a substantial portion, for example more than 50% by weight, more than 70% by weight, or even more than 90% by weight, of the balance of components of the cleaning composition. For example, in the methodology described above, both the mixture of polyglycerol estersmixture of polyglycerol esters premix and the enzyme component are added at a final stage of component additions. In another aspect, the mixture of polyglycerol estersmixture of polyglycerol esters is encapsulated prior to addition to the detergent composition, the encapsulated mixture of polyglycerol estersmixture of polyglycerol esters is suspended in a structured liquid, and the suspension is added to a composition formulation containing a substantial portion of the balance of components of the cleaning composition.

### EXAMPLE 3

### Heavy Duty Liquid Laundry Detergent Formulation

In this Example, three sample formulations for a heavy duty liquid (HDL) laundry detergent are prepared using the mixture of polyglycerol esters according to embodiments of the present disclosure. The mixture of polyglycerol esters is added to the formulations in an amount ranging from 0.5% to 2.0% by weight.

| | A | B | C | D | E |
|---|---|---|---|---|---|
| Ingredient | Wt % | Wt % | Wt % | Wt % | Wt % |
| Sodium alkyl ether sulfate | 20.5 | 20.5 | 20.5 | | |
| C12-15 Alkyl Polyethoxylate (1.1) | | | | 9.0 | |
| Sulfonic Acid | | | | | |
| Branched alcohol sulfate | 5.8 | 5.8 | 5.8 | | |
| Linear alkylbenzene sulfonic acid | 2.5 | 2.5 | 2.5 | 1.0 | 8.0 |
| Alkyl ethoxylate | 0.8 | 0.8 | 0.8 | 1.5 | 6.0 |
| Amine oxide | 0 | 0.5 | 2 | | 1.0 |
| Citric acid | 3.5 | 3.5 | 3.5 | 2.0 | 2.5 |
| Fatty acid | 2.0 | 2.0 | 2.0 | | 5.5 |
| Protease | 0.7 | 0.7 | 0.7 | 0.4 | 0.4 |
| Amylase | 0.37 | 0.37 | 0.37 | 0.08 | 0.08 |
| Mannanase | | | | 0.03 | 0.03 |
| Borax (38%) | 3.0 | 3.0 | 3.0 | 1.0 | |
| MEA Borate | | | | | 1.5 |
| Calcium and sodium formate | 0.22 | 0.22 | 0.22 | 0.7 | |
| Amine ethoxylate polymers | 1.2 | 0.5 | 1.0 | 1.0 | 1.5 |
| Zwitterionic amine ethoxylate polymer | 1.0 | 2.0 | 1.0 | | |
| PGE-1^{a} | 3.0 | 3.0 | 6.0 | 6.0 | 0.0 |
| PGE-2^{b} | 0.0 | 0.0 | 0.0 | 0.0 | 3.0 |
| DTPA^{c} | 0.25 | 0.25 | 0.25 | 0.3 | 0.3 |
| Fluorescent whitening agent | 0.2 | 0.2 | 0.2 | | |
| Ethanol | 2.9 | 2.9 | 2.9 | 1.5 | 1.5 |
| Propylene Glycol | | | | 3.0 | 5.0 |
| Propanediol | 5.0 | 5.0 | 5.0 | | |
| Diethylene glycol | 2.56 | 2.56 | 2.56 | | |
| Polyethylene glycol 4000 | 0.11 | 0.11 | 0.11 | | |
| Monoethanolamine | 2.7 | 2.7 | 2.7 | 1.0 | 0.5 |
| Sodium hydroxide (50%) | 3.67 | 3.67 | 3.67 | 1.4 | 1.4 |
| Sodium cumene sulfonate | 0 | 0.5 | 1 | | 0.7 |
| Silicone suds suppressor | 0.01 | 0.01 | 0.01 | | 0.02 |
| Perfume | 0.5 | 0.5 | 0.5 | 0.30 | 0.3 |
| Dye | 0.01 | 0.01 | 0.01 | 0.016 | 0.016 |
| Opacifier^{d} | 0.01 | 0.01 | 0.01 | | |
| Water | balance | balance | balance | balance | balance |
| | 100.0% | 100.0% | 100.0% | 100.0% | 100.0% |

^{a}PGE-1 = Polyglycerol Ester with average glycerol chain length of 3 and average esterification of 2, crosslinker of dimer Acid, 50% cross-linked
^{b}PGE-2 = Polyglycerol Ester with average glycerol chain length of 3.4 and average esterification of 3, crosslinker of Sebacic Acid, 65% cross-linked
^{c}Diethylenetriaminepentaacetic acid, sodium salt
^{d}Acusol OP 301

TABLE III
Examples of Detergent Compositions comprising PGEs

| | Formulation Example | | | | | | |
|---|---|---|---|---|---|---|---|
| | F15 | F16 | F17 | F18 | F19 | F20 | F21 |
| Ingredient | Wt % | | | | | | |
| PGE-1 ^{a} | 3 | 3 | 6 | 6 | 0 | 0 | 0 |
| PGE-2 ^{b} | 0 | 0 | 0 | 0 | 3 | 3 | 6 |
| Perfume | 1.5 | 1.5 | 1.5 | 1.5 | 1.5 | 1.5 | 1.5 |
| Deposition agent-2 ^{f} | 0.5 | 0 | 0.5 | 0 | 0.5 | 0 | 0.5 |
| Deposition agent-3 ^{g} | 0 | 0.5 | 0 | 0.5 | 0 | 0.5 | 0 |
| NI 45-8 ^{s} | 6.25 | 6.25 | 6.25 | 6.25 | 6.25 | 6.25 | 6.25 |
| AES ^{t} | 10.6 | 10.6 | 10.6 | 10.6 | 10.6 | 10.6 | 10.6 |
| Citric Acid | 4.72 | 4.72 | 4.72 | 4.72 | 4.72 | 4.72 | 4.72 |
| HLAS ^{u} | 0.78 | 0.78 | 0.78 | 0.78 | 0.78 | 0.78 | 0.78 |
| TPK FA ^{v} | 8.75 | 8.75 | 8.75 | 8.75 | 8.75 | 8.75 | 8.75 |
| Zwitterionic Ethylene | 1.4 | 1.4 | 1.4 | 1.4 | 1.4 | 1.4 | 1.4 |
| Diamine ^{w} | | | | | | | |
| DTPMP ^{x} | 0.21 | 0.21 | 0.21 | 0.21 | 0.21 | 0.21 | 0.21 |
| Ethanol | 2.75 | 2.75 | 2.75 | 2.75 | 2.75 | 2.75 | 2.75 |
| Boric Acid | 2.39 | 2.39 | 2.39 | 2.39 | 2.39 | 2.39 | 2.39 |
| Sodium Hydroxide | 5.79 | 5.79 | 5.79 | 5.79 | 5.79 | 5.79 | 5.79 |

| | |
|---|---|
| Water | Balance to 100% |

^{a} PGE-1 = Polyglycerol Ester with average glycerol chain length of 3 and average esterification of 2, crosslinker of dimer Acid, 50% cross-linked
^{b} PGE-2 = Polyglycerol Ester with average glycerol chain length of 3.4 and average esterification of 3, crosslinker of Sebacic Acid, 65% cross-linked
^{s} NI 45- 8 = alcohol ethoxylate with an approximate average chainlength of C14, C15 and an average of 8 ethoxylates.
^{t} AES = alkyl ethoxylate sulfate
^{u} HLAS = H linear alkylbenzene solfonate
^{v} TPK FA = Tall Palm Kernel Fatty Acid
^{w} As described in WO01/62882 (Quaternized trans sulfated hexamethylenediamine)
^{x} DTPMP = diethylene triamine penta(methyl Phosphonic) acid

### Granular Laundry Detergent Compositions

In another aspect of the present disclosure, the fabric care compositions disclosed herein, may take the form of granular laundry detergent compositions. Such compositions comprise the dispersant polymer of the present disclosure to provide soil and stain removal and anti-redeposition, suds boosting, and/or soil release benefits to fabric washed in a solution containing the detergent. Typically, the granular laundry detergent compositions are used in washing solutions at a level of from about 0.0001% to about 0.05%, or even from about 0.001% to about 0.01% by weight of the washing solution.

Detergent compositions may be in the form of a granule. Typical components of granular detergent compositions include but are not limited to surfactants, builders, bleaches, bleach activators and/or other bleach catalysts and/or boosters, enzymes, enzyme stabilizing agents, soil suspending agents, soil release agents, pH adjusting agents and/or other electrolytes, suds boosters or suds suppressers, anti-tarnish and anticorrosion agents, non-builder alkalinity sources, chelating agents, organic and inorganic fillers, solvents, hydrotropes, clays, silicones, flocculant, dye transfer inhibitors, photobleaches, fabric integrity agents, effervescence-generating agents, processing aids (non-limiting examples of which include binders and hydrotropes), germicides, brighteners, dyes, and perfumes. Granular detergent compositions typically comprise from about 1% to 95% by weight of a surfactant. Detersive surfactants utilized can be of the anionic, nonionic, cationic, zwitterionic, ampholytic, amphoteric, or catanionic type or can comprise compatible mixtures of these types.

Granular detergents can be made by a wide variety of processes, non-limiting examples of which include spray drying, agglomeration, fluid bed granulation, marumarisation, extrusion, or a combination thereof. Bulk densities of granular detergents generally range from about 300 g/l-1000 g/l. The average particle size distribution of granular detergents generally ranges from about 250 microns-1400 microns.

Granular detergent compositions of the present disclosure may include any number of conventional detergent ingredients. For example, the surfactant system of the detergent composition may include anionic, nonionic, zwitterionic, ampholytic and cationic classes and compatible mixtures thereof. Detergent surfactants for granular compositions are described in U.S. Pat. Nos. 3,664,961 and 3,919,678. Cationic surfactants include those described in U.S. Pat. Nos. 4,222,905 and 4,239,659.

Non-limiting examples of surfactant systems include the conventional C₁₁-C₁₈ alkyl benzene sulfonates (“LAS”) and primary, branched-chain and random C₁₀-C₂₀ alkyl sulfates (“AS”), the C₁₀-C₁₈ secondary (2,3) alkyl sulfates of the formula CH₃(CH₂)ₓ(CHOSO₃⁻M⁺)CH₃ and CH₃(CH₂)_{y}(CHOSO₃⁻M⁺)CH₂CH₃ where x and (y+1) are integers of at least about 7, preferably at least about 9, and M is a water-solubilizing cation, especially sodium, unsaturated sulfates such as oleyl sulfate, the C₁₀-C₁₈ alkyl alkoxy sulfates (“AEₓS”; especially EO 1-7 ethoxy sulfates), C₁₀-C₁₈ alkyl alkoxy carboxylates (especially the EO 1-5 ethoxycarboxylates), the C₁₀-C₁₈ glycerol ethers, the C₁₀-C₁₈ alkyl polyglycosides and their corresponding sulfated polyglycosides, and C₁₂-C₁₈ alpha-sulfonated fatty acid esters. If desired, the conventional nonionic and amphoteric surfactants such as the C₁₂-C₁₈ alkyl ethoxylates (“AE”) including the so-called narrow peaked alkyl ethoxylates and C₆-C₁₂ alkyl phenol alkoxylates (especially ethoxylates and mixed ethoxy/propoxy), C₁₂-C₁₈ betaines and sulfobetaines (“sultaines”), C₁₀-C₁₈ amine oxides, and the like, can also be included in the surfactant system. The C₁₀-C₁₈ N-alkyl polyhydroxy fatty acid amides can also be used. See WO 92/06154. Other sugar-derived surfactants include the N-alkoxy polyhydroxy fatty acid amides, such as C₁₀-C₁₈ N-(3-methoxypropyl)glucamide. The N-propyl through N-hexyl C₁₂-C₁₈ glucamides can be used for low sudsing. C₁₀-C₂₀ conventional soaps may also be used. If high sudsing is desired, the branched-chain C₁₀-C₁₆ soaps may be used. Mixtures of anionic and nonionic surfactants are especially useful. Other conventional useful surfactants are listed in standard texts.

The cleaning composition can, and in certain embodiments preferably does, include a detergent builder. Builders are generally selected from the various water-soluble, alkali metal, ammonium or substituted ammonium phosphates, polyphosphates, phosphonates, polyphosphonates, carbonates, silicates, borates, polyhydroxy sulfonates, polyacetates, carboxylates, and polycarboxylates. Preferred are the alkali metals, especially sodium, salts of the above. Preferred for use herein are the phosphates, carbonates, silicates, C₁₀-C₁₈ fatty acids, polycarboxylates, and mixtures thereof. More preferred are sodium tripolyphosphate, tetrasodium pyrophosphate, citrate, tartrate mono- and di-succinates, sodium silicate, and mixtures thereof.

Specific examples of inorganic phosphate builders are sodium and potassium tripolyphosphate, pyrophosphate, polymeric metaphosphate having a degree of polymerization of from about 6 to 21, and orthophosphates. Examples of polyphosphonate builders are the sodium and potassium salts of ethylene diphosphonic acid, the sodium and potassium salts of ethane 1-hydroxy-1,1-diphosphonic acid and the sodium and potassium salts of ethane-1,1,2-triphosphonic acid. Other phosphorus builder compounds are disclosed in U.S. Pat. Nos. 3,159,581; 3,213,030; 3,422,021; 3,422,137; 3,400,176; and 3,400,148. Examples of non-phosphorus, inorganic builders are sodium and potassium carbonate, bicarbonate, sesquicarbonate, tetraborate decahydrate, and silicates having a weight ratio of SiO₂ to alkali metal oxide of from about 0.5 to about 4.0, preferably from about 1.0 to about 2.4. Water-soluble, non-phosphorus organic builders useful herein include the various alkali metal, ammonium and substituted ammonium polyacetates, carboxylates, polycarboxylates and polyhydroxy sulfonates. Examples of polyacetate and polycarboxylate builders are the sodium, potassium, lithium, ammonium and substituted ammonium salts of ethylene diamine tetraacetic acid, nitrilotriacetic acid, oxydisuccinic acid, mellitic acid, benzene polycarboxylic acids, and citric acid.

Polymeric polycarboxylate builders are set forth in U.S. Pat. No. 3,308,067. Such materials include the water-soluble salts of homo- and copolymers of aliphatic carboxylic acids such as maleic acid, itaconic acid, mesaconic acid, fumaric acid, aconitic acid, citraconic acid and methylenemalonic acid. Some of these materials are useful as the water-soluble anionic polymer as hereinafter described, but only if in intimate admixture with the non-soap anionic surfactant. Other suitable polycarboxylates for use herein are the polyacetal carboxylates described in U.S. Pat. Nos. 4,144,226 and 4,246,495.

Water-soluble silicate solids represented by the formula SiO₂.M₂O, M being an alkali metal, and having a SiO₂:M₂O weight ratio of from about 0.5 to about 4.0, are useful salts in the detergent granules of this disclosure at levels of from about 2% to about 15% on an anhydrous weight basis. Anhydrous or hydrated particulate silicate can be utilized, as well.

Various techniques for forming cleaning compositions in such solid forms are well known in the art and may be used herein. In one aspect, when the cleaning composition, such as a fabric care composition, is in the form of a granular particle, the mixture of polyglycerol esters is provided in particulate form, optionally including additional but not all components of the cleaning composition. The mixture of polyglycerol esters particulate is combined with one or more additional particulates containing a balance of components of the cleaning composition. Further, the mixture of polyglycerol esters, optionally including additional but not all components of the cleaning composition may be provided in an encapsulated form, and the mixture of polyglycerol esters encapsulate is combined with particulates containing a substantial balance of components of the cleaning composition.

### EXAMPLE 4

### Powder Laundry Detergent Formulation

In this Example, four sample formulations for a powder laundry detergent are prepared using the mixture of polyglycerol esters according to embodiments of the present disclosure. The mixture of polyglycerol esters is added to the formulations in an amount ranging from 1.0% to 3.0% by weight.

| | A | B | C | D |
|---|---|---|---|---|
| Ingredients | Wt. % | Wt. % | Wt. % | Wt. % |
| Sodium alkylbenzenesulfonate | 16.0000 | 14.0000 | 12.0000 | 7.9 |
| Sodium alkyl alcohol ethoxylate | — | — | — | 4.73 |
| (3) sulfate | | | | |
| Sodium mid-cut alkyl sulfate | | 1.5000 | 1.5000 | — |
| Alkyl dimethyl hydroxyethyl | — | — | — | 0.5 |
| quaternary amine (chloride) | | | | |
| Alkyl ethoxylate | 1.3000 | 1.3000 | 1.3000 | — |
| Polyamine¹ | — | — | — | 0.79 |
| Nonionic Polymer² | 1.0000 | 1.0000 | 1.0000 | 1.0 |
| Carboxymethylcellulose | 0.2000 | 0.2000 | 0.2000 | 1.0 |
| Sodium polyacrylate | — | — | — | — |
| Sodium polyacrylate/maleate | 0.7000 | 0.7000 | 0.7000 | 3.5 |
| polymer | | | | |
| PGE-1^{a} | 3 | 3 | 6 | 6 |
| PGE-2^{b} | 0 | 0 | 0 | 0 |
| Sodium tripolyphosphate | 10.0000 | 5.0000 | — | — |
| Zeolite | 16.0000 | 16.0000 | 16.0000 | — |
| Citric Acid | — | — | — | 5.0 |
| Sodium Carbonate | 12.5000 | 12.5000 | 12.5000 | 25.0 |
| Sodium Silicate | 4.0 | 4.0 | 4.0 | — |
| Enzymes³ | 0.30 | 0.30 | 0.30 | 0.5 |
| Minors including moisture⁴ | balance | balance | balance | balance |

¹Hexamethylenediamine ethoxylated to 24 units for each hydrogen atom bonded to a nitrogen, quaternized.
²Comb polymer of polyethylene glycol and polyvinylacetate
³Enzyme cocktail selected from known detergent enzymes including amylase, cellulase, protease, and lipase.
⁴Balance to 100% can, for example, include minors like optical brightener, perfume, suds suppresser, soil dispersant, soil release polymer, chelating agents, bleach additives and boosters, dye transfer inhibiting agents, aesthetic enhancers (example: Speckles), additional water, and fillers, including sulfate, CaCO₃, talc, silicates, etc.
^{a}PGE-1 = Polyglycerol Ester with average glycerol chain length of 3 and average esterification of 2, crosslinker of dimer Acid, 50% cross-linked
^{b}PGE-2 = Polyglycerol Ester with average glycerol chain length of 3.4 and average esterification of 3, crosslinker of Sebacic Acid, 65% cross-linked

### EXAMPLE 5

### Automatic Dishwasher Detergent Formulation

In this Example, five sample formulations for an automatic dishwasher detergent are prepared using the mixture of polyglycerol esters according to embodiments of the present disclosure. The mixture of polyglycerol esters is added to the formulations in an amount ranging from 0.05% to 15% by weight.

| | A | B | C | D | E |
|---|---|---|---|---|---|
| Ingredients | Wt. % | Wt. % | Wt. % | Wt. % | Wt. % |
| Polymer dispersant¹ | 0.5 | 5 | 6 | 5 | 5 |
| Carbonate | 35 | 40 | 40 | 35-40 | 35-40 |
| Sodium tripolyphosphate | 0 | 6 | 10 | 0-10 | 0-10 |
| Silicate soilds | 6 | 6 | 6 | 6 | 6 |
| Bleach and Bleach | 4 | 4 | 4 | 4 | 4 |
| activators | | | | | |
| Enzymes | 0.3-0.6 | 0.3-0.6 | 0.3-0.6 | 0.3-0.6 | 0.3-0.6 |
| Disodium citrate dihydrate | 0 | 0 | 0 | 2-20 | 0 |
| Nonionic surfactant² | 0 | 0 | 0 | 0 | 0.8-5 |
| PGE-1^{a} | 3 | 3 | 6 | 6 | 6 |
| PGE-2^{b} | 0 | 0 | 0 | 0 | |
| Water, sulfate, perfume, | Balance to | Balance to | Balance to | Balance to | Balance to |
| dyes and other adjuncts | 100% | 100% | 100% | 100% | 100% |

¹Anionic polymers such as Acusol, Alcosperse and other modified polyacrylic acid polymers.
²Such as SLF-18 polytergent from Olin Corporation
^{a}PGE-1 = Polyglycerol Ester with average glycerol chain length of 3 and average esterification of 2, crosslinker of dimer Acid, 50% cross-linked
^{b}PGE-2 = Polyglycerol Ester with average glycerol chain length of 3.4 and average esterification of 3, crosslinker of Sebacic Acid, 65% cross-linked

### Liquid Dishwashing Liquid

### EXAMPLE XXIII

### Liquid Dish Handwashing Detergents

| Composition | A | B |
|---|---|---|
| C₁₂₋₁₃ Natural AE0.6S | 270 | 240 |
| C₁₀₋₁₄ mid-branched Amine Oxide | — | 6.0 |
| Poly-branched Alcohol Ethoxylate | 2.0 | 5.0 |
| according to SYNTHETIC | | |
| EXAMPLES XIII through XX | | |
| C₁₂₋₁₄ Linear Amine Oxide | 6.0 | — |
| SAFOL ® 23 Amine Oxide | 1.0 | 1.0 |
| C₁₁E₉ Nonionic¹ | 2.0 | 2.0 |
| Ethanol | 4.5 | 4.5 |
| Sodium cumene sulfonate | 1.6 | 1.6 |
| Polypropylene glycol 2000 | 0.8 | 0.8 |
| NaCl | 0.8 | 0.8 |
| 1,3 BAC Diamine² | 0.5 | 0.5 |
| PGE-1^{a} | 3 | 0 |
| PGE-2^{b} | 0 | 6 |
| Water | Balance | Balance |

¹Nonionic may be either C₁₁ Alkyl ethoxylated surfactant containing 9 ethoxy groups.
²1,3, BAC is 1,3 bis(methylamine)-cyclohexane.
^{a}PGE-1 = Polyglycerol Ester with average glycerol chain length of 3 and average esterification of 2, crosslinker of dimer Acid, 50% cross-linked
^{b}PGE-2 = Polyglycerol Ester with average glycerol chain length of 3.4 and average esterification of 3, crosslinker of Sebacic Acid, 65% cross-linked

### Unit Dose

The detergent product of the present invention is a water-soluble pouch, more preferably a multi-compartment water-soluble pouch. The pouch comprises a water-soluble film and at least a first, and optionally a second compartment. The first compartment comprises a first composition, comprising an opacifier and an antioxidant. The second compartment comprises a second compartment. Preferably the pouch comprises a third compartment and a third composition. The optionally second and third compositions are preferably visibly distinct from each other and the first composition.

A difference in aesthetic appearance can be achieved in a number of ways, however the first compartment of the present pouch comprises an opaque liquid composition. The compartments of the pouch may be the same size or volume. Alternatively, the compartments of the pouch may have different sizes, with different internal volumes. The compartments may also be different from one another in terms of texture. Hence one compartment may be glossy, whilst the other is matt. This can be readily achieved as one side of a water-soluble film is often glossy, whilst the other has a matt finish. Alternatively the film used to make a compartment may be treated in a way so as to emboss, engrave or print the film. Embossing may be achieved by adhering material to the film using any suitable means described in the art. Engraving may be achieved by applying pressure onto the film using any suitable technique available in the art. Printing may be achieved using any suitable printer and process available in the art. Alternatively, the film itself may be coloured, allowing the manufacturer to select different coloured films for each compartment. Alternatively the films may be transparent or translucent and the composition contained within may be coloured. Thus in a preferred embodiment of the present invention the first compartment contains an opaque product, coloured any colour selected from the group consisting of white, green, blue, orange, red, yellow, pink or purple, preferably white. The second and subsequent compartment preferably has a different colour and is coloured a colour selected from the group consisting of yellow, orange, pink, purple, blue or green, more preferably green or blue. In one embodiment the multi-compartment pouch comprises a first compartment which is opaque and white and second and third compartments which are coloured toning colours of green or blue.

The compartments of the present multi-compartment pouches can be separate, but are preferably conjoined in any suitable manner. Most preferably the second and optionally third or subsequent compartments are superimposed on the first compartment. In one embodiment, the third compartment may be superimposed on the second compartment, which is in turn superimposed on the first compartment in a sandwich configuration. Alternatively the second and third compartments are superimposed on the first compartment. However it is also equally envisaged that the first, second and optionally third and subsequent compartments may be attached to one another in a side by side relationship. The compartments may be packed in a string, each compartment being individually separable by a perforation line. Hence each compartment may be individually torn-off from the remainder of the string by the end-user, for example, so as to pre-treat or post-treat a fabric with a composition from a compartment.

In a preferred embodiment the present pouch comprises three compartments consisting of a large first compartment and two smaller compartments. The second and third smaller compartments are superimposed on the first larger compartment. The size and geometry of the compartments are chosen such that this arrangement is achievable.

The geometry of the compartments may be the same or different. In a preferred embodiment the second and optionally third compartment have a different geometry and shape to the first compartment. In this embodiment the second and optionally third compartments are arranged in a design on the first compartment. Said design may be decorative, educative, illustrative for example to illustrate a concept or instruction, or used to indicate origin of the product. In a preferred embodiment the first compartment is the largest compartment having two large faces sealed around the perimeter. The second compartment is smaller covering less than 75%, more preferably less than 50% of the surface area of one face of the first compartment. In the embodiment wherein there is a third compartment, the above structure is the same but the second and third compartments cover less than 60%, more preferably less than 50%, even more preferably less than 45% of the surface area of one face of the first compartment.

The pouch is preferably made of a film material which is soluble or dispersible in water, and has a water-solubility of at least 50%, preferably at least 75% or even at least 95%, as measured by the method set out here after using a glass-filter with a maximum pore size of 20 microns:
50 grams±0.1 gram of pouch material is added in a pre-weighed 400 ml beaker and 245 ml±1 ml of distilled water is added. This is stirred vigorously on a magnetic stirrer set at 600 rpm, for 30 minutes. Then, the mixture is filtered through a folded qualitative sintered-glass filter with a pore size as defined above (max. 20 micron). The water is dried off from the collected filtrate by any conventional method, and the weight of the remaining material is determined (which is the dissolved or dispersed fraction). Then, the percentage solubility or dispersability can be calculated.

Preferred pouch materials are polymeric materials, preferably polymers which are formed into a film or sheet. The pouch material can, for example, be obtained by casting, blow-moulding, extrusion or blown extrusion of the polymeric material, as known in the art.

Preferred polymers, copolymers or derivatives thereof suitable for use as pouch material are selected from polyvinyl alcohols, polyvinyl pyrrolidone, polyalkylene oxides, acrylamide, acrylic acid, cellulose, cellulose ethers, cellulose esters, cellulose amides, polyvinyl acetates, polycarboxylic acids and salts, polyaminoacids or peptides, polyamides, polyacrylamide, copolymers of maleic/acrylic acids, polysaccharides including starch and gelatine, natural gums such as xanthum and carragum. More preferred polymers are selected from polyacrylates and water-soluble acrylate copolymers, methylcellulose, carboxymethylcellulose sodium, dextrin, ethylcellulose, hydroxyethyl cellulose, hydroxypropyl methylcellulose, maltodextrin, polymethacrylates, and most preferably selected from polyvinyl alcohols, polyvinyl alcohol copolymers and hydroxypropyl methyl cellulose (HPMC), and combinations thereof. Preferably, the level of polymer in the pouch material, for example a PVA polymer, is at least 60%. The polymer can have any weight average molecular weight, preferably from about 1000 to 1,000,000, more preferably from about 10,000 to 300,000 yet more preferably from about 20,000 to 150,000.

Mixtures of polymers can also be used as the pouch material. This can be beneficial to control the mechanical and/or dissolution properties of the compartments or pouch, depending on the application thereof and the required needs. Suitable mixtures include for example mixtures wherein one polymer has a higher water-solubility than another polymer, and/or one polymer has a higher mechanical strength than another polymer. Also suitable are mixtures of polymers having different weight average molecular weights, for example a mixture of PVA or a copolymer thereof of a weight average molecular weight of about 10,000-40,000, preferably around 20,000, and of PVA or copolymer thereof, with a weight average molecular weight of about 100,000 to 300,000, preferably around 150,000. Also suitable herein are polymer blend compositions, for example comprising hydrolytically degradable and water-soluble polymer blends such as polylactide and polyvinyl alcohol, obtained by mixing polylactide and polyvinyl alcohol, typically comprising about 1-35% by weight polylactide and about 65% to 99% by weight polyvinyl alcohol. Preferred for use herein are polymers which are from about 60% to about 98% hydrolysed, preferably about 80% to about 90% hydrolysed, to improve the dissolution characteristics of the material.

Naturally, different film material and/or films of different thickness may be employed in making the compartments of the present invention. A benefit in selecting different films is that the resulting compartments may exhibit different solubility or release characteristics.

Most preferred pouch materials are PVA films known under the trade reference Monosol M8630, as sold by Chris-Craft Industrial Products of Gary, Ind., US, and PVA films of corresponding solubility and deformability characteristics. Other films suitable for use herein include films known under the trade reference PT film or the K-series of films supplied by Aicello, or VF-HP film supplied by Kuraray.

The pouch material herein can also comprise one or more additive ingredients. For example, it can be beneficial to add plasticisers, for example glycerol, ethylene glycol, diethyleneglycol, propylene glycol, sorbitol and mixtures thereof. Other additives include functional detergent additives to be delivered to the wash water, for example organic polymeric dispersants, etc.

For reasons of deformability pouches or pouch compartments containing a component which is liquid will preferably contain an air bubble having a volume of up to about 50%, preferably up to about 40%, more preferably up to about 30%, more preferably up to about 20%, more preferably up to about 10% of the volume space of said compartment.

Process for Making the Water-Soluble Pouch

The process of the present invention may be made using any suitable equipment and method. Single compartment pouches are made using vertical, but preferably horizontal form filling techniques commonly known in the art. The film is preferably dampened, more preferably heated to increase the malleability thereof. Even more preferably, the method also involves the use of a vacuum to draw the film into a suitable mould. The vacuum drawing the film into the mould can be applied for 0.2 to 5 seconds, preferably 0.3 to 3 or even more preferably 0.5 to 1.5 seconds, once the film is on the horizontal portion of the surface. This vacuum may preferably be such that it provides an under-pressure of between −100 mbar to −1000 mbar, or even from −200 mbar to −600 mbar.

The moulds, in which the pouches are made, can have any shape, length, width and depth, depending on the required dimensions of the pouches. The moulds can also vary in size and shape from one to another, if desirable. For example, it may be preferred that the volume of the final pouches is between 5 and 300 ml, or even 10 and 150 ml or even 20 and 100 ml and that the mould sizes are adjusted accordingly.

Heat can be applied to the film, in the process commonly known as thermoforming, by any means. For example the film may be heated directly by passing it under a heating element or through hot air, prior to feeding it onto the surface or once on the surface. Alternatively it may be heated indirectly, for example by heating the surface or applying a hot item onto the film. Most preferably the film is heated using an infra red light. The film is preferably heated to a temperature of 50 to 120° C., or even 60 to 90° C. Alternatively, the film can be wetted by any mean, for example directly by spraying a wetting agent (including water, solutions of the film material or plasticizers for the film material) onto the film, prior to feeding it onto the surface or once on the surface, or indirectly by wetting the surface or by applying a wet item onto the film.

Once a film has been heated/wetted, it is drawn into an appropriate mould, preferably using a vacuum. The filling of the moulded film can be done by any known method for filling (preferably moving) items. The most preferred method will depend on the product form and speed of filling required. Preferably the moulded film is filled by in-line filling techniques. The filled, open pouches are then closed, using a second film, by any suitable method. Preferably, this is also done while in horizontal position and in continuous, constant motion. Preferably the closing is done by continuously feeding a second film, preferably water-soluble film, over and onto the open pouches and then preferably sealing the first and second film together, typically in the area between the moulds and thus between the pouches.

Preferred methods of sealing include heat sealing, solvent welding, and solvent or wet sealing. It is preferred that only the area which is to form the seal, is treated with heat or solvent. The heat or solvent can be applied by any method, preferably on the closing material, preferably only on the areas which are to form the seal. If solvent or wet sealing or welding is used, it may be preferred that heat is also applied. Preferred wet or solvent sealing/welding methods include applying selectively solvent onto the area between the moulds, or on the closing material, by for example, spraying or printing this onto these areas, and then applying pressure onto these areas, to form the seal. Sealing rolls and belts as described above (optionally also providing heat) can be used, for example.

The formed pouches can then be cut by a cutting device. Cutting can be done using any known method. It may be preferred that the cutting is also done in continuous manner, and preferably with constant speed and preferably while in horizontal position. The cutting device can, for example, be a sharp item or a hot item, whereby in the latter case, the hot item ‘burns’ through the film/sealing area.

The different compartments of a multi-compartment pouch may be made together in a side-by-side style and consecutive pouches are not cut. Alternatively, the compartments can be made separately. According to this process and preferred arrangement, the pouches are made according to the process comprising the steps of:

a) forming an first compartment (as described above);

b) forming a recess within some or all of the closed compartment formed in step (a), to generate a second moulded compartment superposed above the first compartment;

c) filling and closing the second compartments by means of a third film;

d) sealing said first, second and third films; and

e) cutting the films to produce a multi-compartment pouch.

Said recess formed in step b is preferably achieved by applying a vacuum to the compartment prepared in step a).

Alternatively the second, and optionally third, compartment(s) can be made in a separate step and then combined with the first compartment as described in our co-pending application EP 08101442.5 which is incorporated herein by reference. A particularly preferred process comprises the steps of:

a) forming a first compartment, optionally using heat and/or vacuum, using a first film on a first forming machine;

b) filling said first compartment with a first composition;

c) on a second forming machine, deforming a second film, optionally using heat and vacuum, to make a second and optionally third moulded compartment;

d) filling the second and optionally third compartments;

e) sealing the second and optionally third compartment using a third film;

f) placing the sealed second and optionally third compartments onto the first compartment;

g) sealing the first, second and optionally third compartments; and

h) cutting the films to produce a multi-compartment pouch

The first and second forming machines are selected based on their suitability to perform the above process. The first forming machine is preferably a horizontal forming machine. The second forming machine is preferably a rotary drum forming machine, preferably located above the first forming machine.

It will be understood moreover that by the use of appropriate feed stations, it is possible to manufacture multi-compartment pouches incorporating a number of different or distinctive compositions and/or different or distinctive liquid, gel or paste compositions.

Detergent Composition

The first composition of the present invention is a liquid. By the term ‘liquid’ it is meant to include liquid, paste, waxy or gel compositions. The liquid composition may comprise a solid. Solids may include powder or agglomerates, such as micro-capsules, beads, noodles or one or more pearlised balls or mixtures thereof. Such a solid element may provide a technical benefit, through the wash or as a pre-treat, delayed or sequential release component. Alternatively it may provide an aesthetic effect.

The first compartment comprises the main wash detergent composition. Said composition comprises an opacifier and antioxidant. Second and third compositions, where present preferably comprise a colouring agent and do not comprise an opacifier. The weight ratio of the first to second or third liquid compositions, where present, is preferably from 1:1 to 20:1, more preferably from 2:1 to 10:1. The weight ratio of the second to third composition, where present, is from 1:5 to 5:1, more preferably 1:2 to 2:1. Most preferably the weight ratio of second to third composition is 1:1

The construction of the multi-compartment pouch according to the present invention provides benefits in terms of aesthetic appeal. A further benefit of said construction is the ability to separate, otherwise incompatible, ingredients. In a preferred aspect of the present invention, the first composition comprises an opacifier. Second and/or third compositions are preferably darker than the first composition.

Other ingredients that could preferably be separated include whitening agents that are sensitive to other constituents of the composition. For example triphenyl methane whitening agents are sensitive to pH, becoming unstable in compositions with pH greater than 9 and Thiazolium whitening agents are not stable in the presence of perfumes. The pH of the composition containing the whitening agent could thus be separated from the main detergent ingredients comprising a higher pH and perfume. Equally cationic species are incompatible with an overtly anionic composition. Hence for example when a composition comprises high levels of anionic surfactants, cationic surfactants, which provide improved cleaning, or polymers such as deposition aids, can be separated into a different compartment. A bleach system or components of a bleaching system may be other ingredients that could be successfully separated from the main detergent composition. Bleach systems are difficult to formulate in liquid environments as the bleach becomes unstable and/or degrades.

### Unit Dose Composition

| | Wt % |
|---|---|
| Glycerol (min 99) | 5.3 |
| 1,2-propanediol | 10.0 |
| Citric Acid | 0.5 |
| Monoethanolamine | 10.0 |
| Caustic soda | — |
| Dequest 2010 | 1.1 |
| Potassium sulfite | 0.2 |
| Nonionic Marlipal C24EO7 | 20.1 |
| HLAS | 24.6 |
| Optical brightener FWA49 | 0.2 |
| PGE-1^{a} | 6.0 |
| C12-15 Fatty acid | 16.4 |
| Polymer Lutensit Z96 | 2.9 |
| Polyethyleneimine ethoxylate PEI600 E20 | 1.1 |
| MgCl2 | 0.2 |
| Enzymes | ppm |

^{a}PGE-1 = Polyglycerol Ester with average glycerol chain length of 3 and average esterification of 2, crosslinker of dimer Acid, 50% cross-linked

### Tablet

The first step of manufacturing tablets usually involves granulating raw materials such as agglomeration. The granules are then combined with other actives, a binder and compressed into tablet form, e.g. using a rotary press. Due to the compaction force, tablets dissolve slower than powders with the same actives. Thus, combining good mechanical stability and rapid dissolution is a key challenge. Several approaches have been developed, e.g. high levels of water-soluble salts or the use of swellable polymers. Another approach is to generate a tablet with a softer, more readily dissolved core, coated with a harder protective ‘shell’ that breaks easily when exposed to water. Preferred coatings include dicarboxylic acids and a disintegrant. Preferred density of these tablets is in the range of 1020-1070 g/l, preferred shape is rectangular and preferably used via the dosing drawer. Usual density for other tablets is 1200-1400 g/l. Tablets can be dosed via the drum, potentially in a net, of via the dosing drawer.

### Fabric Softeners—Liquids

Liquid fabric softening compositions (such as those marked under the brand name DOWNY) comprise a fabric softening active. One class of fabric softener actives includes cationic surfactants. Examples of cationic surfactants include quaternary ammonium compounds. Exemplary quaternary ammonium compounds include alkylated quaternary ammonium compounds, ring or cyclic quaternary ammonium compounds, aromatic quaternary ammonium compounds, diquaternary ammonium compounds, alkoxylated quaternary ammonium compounds, amidoamine quaternary ammonium compounds, ester quaternary ammonium compounds, and mixtures thereof. A final fabric softening composition (suitable for retail sale) will comprise from about 1% to about 30%, alternatively from about 10% to about 25%, alternatively from about 15 to about 20%, alternatively from about 0.1% to about 5%, alternatively combinations thereof, of fabric softening active by weight of the final composition. Fabric softening compositions, and components thereof, are generally described in US 2004/0204337. In one embodiment, the fabric softening composition is a so called rinse added composition. In such embodiment, the composition is substantially free of detersive surfactants, alternatively substantially free of anionic surfactants. In another embodiment, the pH of the fabric softening composition is acidic, for example between pH 2 and 4. In yet another embodiment, the fabric softening active is DEEDMAC (e.g., ditallowoyl ethanolester dimethyl ammonium chloride). DEEDMAC means mono and di-fatty acid ethanol ester dimethyl ammonium quaternaries, the reaction products of straight chain fatty acids, methyl esters and/or triglycerides (e.g., from animal and/or vegetable fats and oils such as tallow, palm oil and the like) and methyl diethanol amine to form the mono and di-ester compounds followed by quaternization with an aklyating agent. See U.S. Pat. Nos. 4,767,547; 5,460,736; 5,474,690; 5,545,340; 5,545,350; 5,562,849. A suitable supplier of fabric softening active may include Evonik Degussa Corporation.

Adjunct ingredients that may be added to the fabric enhancer compositions of the present invention. The ingredients may include: suds suppressor, preferably a silicone suds suppressor (US 2003/0060390 A1, ¶ 65-77)1 cationic starches (U.S. Pat. No. 7,135,451; U.S. Pat. No. 7,625,857); scum dispersants (US 2003/0126282 A1, ¶89-90); perfume and perfume microcapsules (U.S. Pat. No. 5,137,646); nonionic surfactant, non-aqueous solvent, fatty acid, dye, preservatives, optical brighteners, antifoam agents, and combinations thereof. Other adjunct ingredients may include: dispersing agent, stabilizer, pH control agent, metal ion control agent, colorant, brightener, dye, odor control agent, pro-perfume, cyclodextrin, solvent, soil release polymer, preservative, antimicrobial agent, chlorine scavenger, enzyme, anti-shrinkage agent, fabric crisping agent, spotting agent, anti-oxidant, anti-corrosion agent, bodying agent, drape and form control agent, smoothness agent, static control agent, wrinkle control agent, sanitization agent, disinfecting agent, germ control agent, mold control agent, mildew control agent, antiviral agent, anti-microbial, drying agent, stain resistance agent, soil release agent, malodor control agent, fabric refreshing agent, chlorine bleach odor control agent, dye fixative, dye transfer inhibitor, color maintenance agent, color restoration/rejuvenation agent, anti-fading agent, whiteness enhancer, anti-abrasion agent, wear resistance agent, fabric integrity agent, anti-wear agent, and rinse aid, UV protection agent, sun fade inhibitor, insect repellent, anti-allergenic agent, enzyme, flame retardant, water proofing agent, fabric comfort agent, water conditioning agent, shrinkage resistance agent, stretch resistance agent, enzymes, cationic starch, and combinations thereof. In one embodiment, the composition comprises one or more adjunct ingredient up to about 2% by weight of the composition. In yet another embodiment, the composition of the present invention may be free or essentially free of any one or more adjunct ingredients. In yet another embodiment, the composition is free or essentially free of detersive surfactants.

Another aspect of the invention provides for a dryer bar composition. Non-limiting examples of such compositions and articles are described in U.S. Pat. Nos. 6,779,740; 6,883,723; 6,899,281; 6,908,041; 6,910,640; 6,910,641; 7,055,761; 7,087,572; 7,093,772; 7,250,393; 7,309,026; 7,381,697; 7,452,855; 7,456,145.

Another aspect of the invention provides for a dryer sheet coat mix composition. Non-limiting example of such compositions and dryer sheet articles are described in U.S. Pat. Nos. 5,929,026; 5,883,069; 5,574,179; 5,562,849; 5,545,350; 5,545,340; 5,476,599; 5,470,492; 4,981,239; 4,767,547.

Another aspect of the invention provides for a fabric spray composition. Non-limiting example of such compositions and articles are described in U.S. Pat. Nos. 5,798,107; 6,001,343; 6,491,840; 6,495,058; 6,573,233. Method of treating fabric comprises the step of spraying a composition with a fabric spray composition.

### EXAMPLE

### Methods of Making Liquid Softener Compositions Comprising PGE

PGE materials are first emulsified to obtain an ending concentration of 25% PGE, 5% cetyl trimethylammonumchloride (CTMAC) and 3.2% Tergitol TMN-6 (nonionic surfactant available from Dow Chemical). The PGE raw material may then be heated until just above its melting point then mixed with the TMN-6 and stirred until evenly mixed. This mixture is then added slowly to a heated (melting temp of PGE) container containing CTMAC and mixed with an overhead mixer (IKA Lobartechnik, model # RWZODZM-N) at 1500 rpm until all of the PGE/TMN-6 is added and a creamy white emulsion is obtained. Deionized water is added slowly to mixture while being stirred at 1500 rpm to obtain desired end concentration. The mixture is cooled in ice bath to room temperature.

The PGE emulsion is then mixed with premade quat softener base, such as that described in U.S. Pat. No. 6,492,322 B1 using a Hauschild Engineering Speed Mixer (model # DAC60FV2) at 3000 rpm for 2 minutes. D.I. water is then added to the softener system and speed-mixed at 3000 rpm for 1 minute. Next the deposition aid polymer is added and the system is speed-mixed at 3000 rpm for 1 minute. The perfume is then added and speed-mixed at 3000 rpm for 2 minutes. pH of system is then adjusted to 3.2 using concentrated HCL and speed-mixed for 3000 rpm for 1 minute. Final LFE formulation is a creamy white liquid.

Examples of Softening Compositions using the PGEs described herein are listed in Tables I and II. Table III exemplifies laundry detergents in accordance with the instant disclosure.

TABLE I
Examples of Softening Compositions comprising PGEs

| | Formulation Examples | | | | | | |
|---|---|---|---|---|---|---|---|
| | F1 | F2 | F3 | F4 | F5 | F6 | F7 |
| Ingredient | Wt % | | | | | | |
| PGE-1 ^{a} | 14 | 14 | 14 | 14 | 20 | 0 | 0 |
| PGE-2 ^{b} | 0 | 0 | 0 | 0 | 0 | 14 | 14 |
| CTMAC ^{c} | 3 | 3 | 3 | 3 | 3 | 3 | 3 |
| Tergitol TMN-6 ^{d} | 2 | 2 | 2 | 2 | 2 | 2 | 2 |
| Perfume | 1.5 | 1.5 | 1.5 | 1.5 | 1.5 | 1.5 | 1.5 |
| Deposition agent-1 ^{e} | 2 | 0 | 0 | 0 | 2 | 2 | 0 |
| Deposition agent-2 ^{f} | 0.5 | 0.5 | 0 | 0 | 0.5 | 0.5 | 0.5 |
| Deposition agent-3 ^{g} | 0 | 0 | 0.5 | 0 | 0 | 0 | 0 |
| Deposition agent-4 ^{h} | 0 | 0 | 0 | 0.5 | 0 | 0 | 0 |
| Lactic acid | 0.5 | 0.5 | 0.5 | 0.5 | 0.5 | 0.5 | 0.5 |
| Proxel ⁱ | 0.1 | 0.1 | 0.1 | 0.1 | 0.1 | 0.1 | 0.1 |
| Dantoguard ^{j} | 0.15 | 0.15 | 0.15 | 0.15 | 0.15 | 0.15 | 0.15 |
| TMBA ^{k} | 0.05 | 0.05 | 0.05 | 0.05 | 0.05 | 0.05 | 0.05 |
| DPTA ^{l} | 0.05 | 0.05 | 0.05 | 0.05 | 0.05 | 0.05 | 0.05 |

| | |
|---|---|
| Water | Balance to 100% |

^{a} PGE-1 = Polyglycerol Ester with average glycerol chain length of 3 and average esterification of 2, crosslinker of dimer Acid, 50% cross-linked
^{b} PGE-2 = Polyglycerol Ester with average glycerol chain length of 3.4 and average esterification of 3, crosslinker of Sebacic Acid, 65% cross-linked
^{c} CTMAC = Cetyl Trimethyl Ammonium Chloride
^{d} Nonionic surfactant derived from 2,6,8-trimethyl-4-nonanol with ethylene oxide.
^{e} Catatonically modified polysaccharide from National Starch
^{f} Polyvinylamine (PVAm) from BASF
^{g} Polytheylenimine (PEI) from BASF
^{h} Polyacrylamide Methacrylate amidopropyl/Trimethylammonium Chloride (PAM/MAPTAC) from
ⁱ Proxel = 1,2 Benzisothiozolin-3-one
^{j} Dantoguard = Dimethylol-5,5-Dimethylhydanotoin
^{k} TMBA = Trimethoxy Benzoic Acid
^{l} DTPA = Sodium Diethylene Triamine Pentaacetate from NALCO

TABLE II
Examples of Softening Compositions comprising PGEs

| | Formulation Example | | | | | | |
|---|---|---|---|---|---|---|---|
| | F8 | F9 | F10 | F11 | F12 | F13 | F14 |
| Ingredient | Wt % | | | | | | |
| PGE-1 ^{a} | 7 | 7 | 10 | 10 | 10 | 0 | 0 |
| PGE-2 ^{b} | 0 | 0 | 0 | 0 | 0 | 7 | 7 |
| CTMAC ^{c} | 3 | 3 | 3 | 3 | 3 | 3 | 3 |
| Tergitol TMN-6 ^{d} | 2 | 2 | 2 | 2 | 2 | 2 | 2 |
| Perfume | 1.5 | 1.5 | 1.5 | 1.5 | 1.5 | 1.5 | 1.5 |
| Deposition agent-1 ^{e} | 2 | 0 | 0 | 0 | 0 | 0 | 0 |
| Deposition agent-3 ^{g} | 0.25 | 0.25 | 0.25 | 0.25 | 0.25 | 0.25 | 0.25 |
| DEEDMAC ^{m} | 7 | 0 | 0 | 5 | 0 | 7 | 0 |
| DTDMAC ⁿ | 0 | 7 | 5 | 0 | 0 | 0 | 7 |
| Glycerin | 0 | 0 | 0 | 0 | 5 | 0 | 0 |
| Lactic acid | 0.5 | 0.5 | 0.5 | 0.5 | 0.5 | 0.5 | 0.5 |
| Proxel ⁱ | 0.1 | 0.1 | 0.1 | 0.1 | 0.1 | 0.1 | 0.1 |
| Dantoguard ^{j} | 0.15 | 0.15 | 0.15 | 0.15 | 0.15 | 0.15 | 0.15 |
| TMBA ^{k} | 0.05 | 0.05 | 0.05 | 0.05 | 0.05 | 0.05 | 0.05 |
| DPTA ^{l} | 0.05 | 0.05 | 0.05 | 0.05 | 0.05 | 0.05 | 0.05 |
| HCl ^{o} | 0.03 | 0.03 | 0.03 | 0.03 | 0.03 | 0.03 | 0.03 |
| DC2310 ^{p} | 0.15 | 0.15 | 0.15 | 0.15 | 0.15 | 0.15 | 0.15 |
| CaCl2 ^{q} | 0.59 | 0.59 | 0.59 | 0.59 | 0.59 | 0.59 | 0.59 |
| Kathon ^{r} | 0.03 | 0.03 | 0.03 | 0.03 | 0.03 | 0.03 | 0.03 |

| | |
|---|---|
| Water | Balance to 100% |

^{a} PGE-1 = Polyglycerol Ester with average glycerol chain length of 3 and average esterification of 2, crosslinker of dimer Acid, 50% cross-linked
^{b} PGE-2 = Polyglycerol Ester with average glycerol chain length of 3.4 and average esterification of 3, crosslinker of Sebacic Acid, 65% cross-linked
^{c, d, e, f, l, j, k, and l} are the same as the above examples
^{m} DTDMAC = Di-Tallow Di-Methyl Ammonium Chloride
ⁿ DEEDMAC = Di-tallowoylethanolester dimethylammonium chloride
^{o} HCL = Hydrochloric Acid
^{p} DC2310 = Silicone sud-suppressor from Dow Corning
^{q} CaCl2 = Calcium Chloride
^{r} Kathon = mixture of 5-chloro-2-methyl-4-isothiazolin-3-one and 2-methyl-4-isothiazolin-3-one

### Processes of Making Cleaning Compositions

The cleaning compositions, such as, but not limited to, the fabric care compositions of the present disclosure can be formulated into any suitable form and prepared by any process chosen by the formulator, non-limiting examples of which are described in U.S. Pat. Nos. 5,879,584; 5,691,297; 5,574,005; 5,569,645; 5,565,422; 5,516,448; 5,489,392; and 5,486,303.

### Methods of Using Fabric Care Compositions

The fabric care compositions disclosed in the present specification may be used to clean or treat a fabric, such as those described herein. Typically at least a portion of the fabric is contacted with an embodiment of the aforementioned fabric care compositions, in neat form or diluted in a liquor, for example, a wash liquor and then the fabric may be optionally washed and/or rinsed. In one aspect, a fabric is optionally washed and/or rinsed, contacted with an embodiment of the aforementioned fabric care compositions and then optionally washed and/or rinsed. For purposes of the present disclosure, washing includes but is not limited to, scrubbing, and mechanical agitation. The fabric may comprise most any fabric capable of being laundered or treated.

The fabric care compositions disclosed in the present specification can be used to form aqueous washing solutions for use in the laundering of fabrics. Generally, an effective amount of such compositions is added to water, preferably in a conventional fabric laundering automatic washing machine, to form such aqueous laundering solutions. The aqueous washing solution so formed is then contacted, preferably under agitation, with the fabrics to be laundered therewith. An effective amount of the fabric care composition, such as the liquid detergent compositions disclosed in the present specification, may be added to water to form aqueous laundering solutions that may comprise from about 500 to about 7,000 ppm or even from about 1,000 to about 3,000 pm of fabric care composition.

In one aspect, the fabric care compositions may be employed as a laundry additive, a pre-treatment composition and/or a post-treatment composition.

While various specific embodiments have been described in detail herein, the present disclosure is intended to cover various different combinations of the disclosed embodiments and is not limited to those specific embodiments described herein. The various embodiments of the present disclosure may be better understood when read in conjunction with the following representative examples. The following representative examples are included for purposes of illustration and not limitation.

### Methods

### Measurement of Fabric Softness

The following measurement procedures employ the Phabrometer Evaluation System FES-2, manufactured by Nu Cybertek, Inc, Davis, Calif. Instrument—Phabrometer Evaluation System, FES-2 with fabric evaluation software version 1.1.3. The circular weight that compresses the terry during phabrometer operation has a mass of 1466 grams. The weight comprises of two identical halves, each weighing 733 grams. The terry is pushed through a ring that has an inside diameter of 37.93 mm. Both the weight and the ring were purchased from Nu Cybertek. The fabric used for the present method is a 13 in.×13 in. white terry cloth, manufactured by Standard Textile. The brand name is Eurotouch and is composed of 100% cotton. The universal product number is 63491624859. The correspondence address for Standard Textile is One Knollcrest Drive, Cincinnati, Ohio 45237. Prior to measurement, fabrics are cut with a die into circles that have a diameter of 11.0 cm. Fabrics must equilibrate in a constant temperature (CT) room for 24 hours before measuring. The CT room temperature is 70° F. with a relative humidity of 50%. Between each fabric measurement, the bottom of the weight, the inside of the ring, and the base in which the ring is sitting are cleaned with an alcohol wipe having 70% isopropyl alcohol and 30% deionized water. Alcohol wipes were purchased from VWR International. The address for VWR is 1310 Goshen Parkway, West Chester, Pa. 19380. The catalog number is 21910-110. The weight and ring are allowed to dry completely before the next measurement. Once used, a fabric swatch cannot be remeasured.

All raw data is exported to Microsoft Excel 2007. There are 108 data points in each exported curve, but only the first 100 are used. Each curve is integrated from 1 to 100 and the sum is reported as the unitless “Extraction Energy”. For each test treatment a minimum of 6 fabric replicates are evaluated (sampling from as many different terry cloths as possible) and a sample Standard Deviation is calculated. “Extraction Energy Reduction” is obtained by subtraction of the average extraction energy of the control samples (minimum of 6) from the extraction energy average of the fabric samples treated with the above disclosed polyglycerol materials (minimum of 6 per each treatment).

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular aspects of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A fabric or household hard surface treatment composition comprising
a mixture of cross-linked polyglycerol partial ester having the structure of Formula (I) 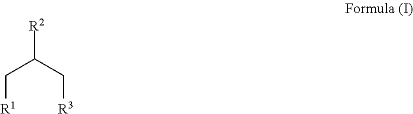
with R¹, R² and R³ each independent from each other, equal or different and selected from the group consisting of
—OH,
—OR⁴, with
R⁴ being a linear, unsubstituted acyl radical with a chain length of from 16 to 22 carbon atoms, having the structure of Formula (II) 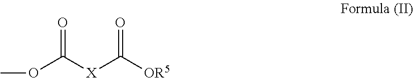
with X a bivalent organic residue with from 2 to 34 carbon atoms and R⁵ being a radical having the structure of Formula (I);
with the proviso that the fatty acids obtained from the acyl radical by saponification of —OR⁴ bears an iodine value of less than or equal to about 50; and
—OR⁵, with R⁵ being a radical having the structure of Formula (I);
wherein each molecule of the mixture of polyglycerol partial esters comprises at least one of each an —OR⁵ and an —OR⁴ radical having the structure of Formula (II) and one of R¹, R² or R³ being a direct bond to the oxygen of —OR⁵;
with the provisos that the mixture of polyglycerol partial esters comprises an HLB-value from about 2 to about 10 and
the polyglycerol obtained by hydrolysis of the polyglycerol partial ester mixture comprises an average degree of condensation of from about 2 to about 8 and at least 1% cyclic structures; and
a carrier material suitable for contact with said fabric.

2. A fabric or household hard surface treatment composition according to claim 1, wherein X is a bivalent, linear, unsubstituted alkyl radical with 2 to 12 carbon atoms.

3. A fabric or household hard surface treatment composition according to claim 1, wherein the mixture of crosslinked polyglycerol esters has an average molecular weight (Mn by GPC) of at least 2000 g/mol.

4. A fabric or household hard surface treatment composition according to claim 1, wherein that the average molar ratio of monocarboxylic acid component to dicarboxylic acid component in the mixture of crosslinked polyglycerol esters ranges from about 2 to about 20.

5. A fabric or household hard surface treatment composition according to claim 1 wherein the mixture of crosslinked polyglycerol esters has a melting point of at least 25° C.

6. A fabric or household hard surface treatment composition according to claim 1, wherein said composition further comprises a quaternary ammonium compound.

7. A fabric or household hard surface treatment composition according to claim 6, wherein said composition comprises a ratio of the polyglycerol ester to the quaternary ammonium compound of from about 10:1 to about 1:5.

8. A fabric or household hard surface treatment composition according to claim 1, wherein said composition has a pH of less than about 7.

9. A fabric or household hard surface treatment composition according to claim 1, wherein said composition comprises less than about 5% of a structurant.

10. A fabric or household hard surface treatment composition according to claim 1, wherein said composition comprises less than about 5% of a detersive surfactant.

11. A fabric or household hard surface treatment composition according to claim 1, wherein said composition comprises a deposition aid and/or a perfume microcapsule.

12. A fabric or household hard surface treatment composition according to claim 1, wherein said composition comprises an organosilicone.

13. A fabric or household hard surface treatment composition according to claim 12, wherein said organosilicone is selected from non-functionalized siloxane polymers, functionalized siloxane polymers, and combinations thereof.

14. A fabric or household hard surface treatment composition according to claim 1, wherein said treatment and/or care agent comprises a material selected from the group consisting of polymers, surfactants, builders, chelating agents, dye transfer inhibiting agents, dispersants, enzymes, and enzyme stabilizers, catalytic materials, bleach activators, polymeric dispersing agents, clay soil removal/anti-redeposition agents, brighteners, suds suppressors, dyes, perfume, perfume delivery systems, structure elasticizing agents, fabric softeners, carriers, ( )hydrotropes, processing aids, pigments, silicones, and combinations thereof.

15. A fabric or household hard surface treatment composition according to claim 1, wherein said composition provides an extraction energy reduction of from about 5 to about 30.

16. An article comprising the fabric or household hard surface treatment composition according to claim 1.

17. A method of treating and/or cleaning a fabric comprising the steps of a) optionally washing and/or rinsing said situs; b) contacting said situs with the fabric or household hard surface treatment composition according to claim 1; and c) optionally, washing and/or rinsing said situs.

18. A method of providing a softening benefit to a fabric, comprising applying the fabric or household hard surface treatment composition of claim 1 to a textile.

19. A method of providing a freshness benefit to a fabric, comprising applying the fabric or household hard surface treatment composition of claim 1 to a fabric, wherein said treatment and/or care agent comprises a perfume.
